(19) United States
(12) Patent Application Publication
(10) Pub. No.: US 2010/0165306 A1
(43) Pub. Date: Jul. 1, 2010

(54) BEAM PROJECTION SYSTEMS AND METHODS

(75) Inventors: Anthony D. McGettigan, Santa Rosa, CA (US); Markus Duelli, Seattle, WA (US); Apurba Pradhan, San Francisco, CA (US)

Correspondence Address: SCHWEGMAN, LUNDBERG & WOESSNER, P.A., P.O. BOX 2938, MINNEAPOLIS, MN, 55402, US

(73) Assignee: Luxmi Corporation, Sunnyvale, CA (US)

(21) Appl. No.: 12/650,643

(22) Filed: Dec. 31, 2009

Related U.S. Application Data
(60) Provisional application No. 61/142,033, filed on Dec. 31, 2008.

(51) Int. Cl. G03B 21/20; G03B 21/28

(52) U.S. Cl. 353/97; 353/98; 353/99; 353/121

(57) ABSTRACT

Throughput efficiency of an optical system is enhanced by using a directional light source coupled to a non-imaging optical element matched to a size and acceptance angle of an imaging lens. In various embodiments, a beam projection system and accompanying method are described that include a lamp body formed from a dielectric material. A bulb, placed adjacent to the lamp body, has a fill that forms a plasma when RF power is coupled to the fill from the lamp body. An optical train is optically coupled to the bulb to transform light generated by the plasma. The optical train includes a non-imaging optical element, an aperture, and at least one imaging lens element.

### RELATED APPLICATION

This application claims priority benefit to U.S. Provisional Patent Application Ser. No. 61/142,033 entitled, “BEAM PROJECTION SYSTEMS AND METHODS,” filed Dec. 31, 2008, which is hereby incorporated by reference in its entirety.

### FIELD OF THE INVENTION

The present invention relates to optical systems for image projection applications. The scope of the invention includes light generation, collection, and imaging. Relevant applications include, for example, entertainment lighting, architectural lighting, security search lights, and exhibit lighting among others.

The following two architectures are examples that are used in spotlighting systems: elliptical reflector) lens systems (see FIG. 1A) and retro-reflector condenser lens systems (see FIG. 1B). A primary goal of each of these systems is to deliver light from the source to the spot as efficiently as possible. A secondary goal is to manage the brightness uniformity, color uniformity, and edge definition in the resulting spot. A third goal is often to minimize the size and cost of the system.

### BACKGROUND

With reference to the prior art systems of FIG. 1A, showing an elliptical reflector-based image projection system, or FIG. 1B, showing a condenser lens-based image projection system, to a first order, either system can be treated as a single lens system where the object is the illumination pattern at the aperture. Thus, the single lens equations apply as follows:

Magnification=S_{image}/S_{Object}

Focal Length=1/(1/S_{image}+1/S_{Object})

Beam Angle≈D_{Object}/S_{Object}≈D_{Image}/S_{Image}

In many cases the desired magnification is large (e.g., greater than 10:1). Consequently,

S_{image}>>S_{Object} and Focal Length≈S_{Object}

Often the application defines the image spot size (D_{Image}) and the image distance (S_{Image}), while the illumination system defines the aperture size (S_{Object}) and the angular distribution at the aperture. Thus, fixing these parameters (D_{Image}, S_{Image}, and S_{Object}) also define the object distance (S_{Object}) and the focal length. As a result, it is common to have a beam projection system where the illumination module is universal and various lens systems are swapped in or out depending on the needs of the particular installation. The lens is designed to create a clean edge on the spot. The clean edge may require optimization techniques to minimize chromatic and other aberrations.

A related issue is that if the beam angle (D_{Image}/S_{Image}) is small, the object size is also small (D_{Object}). Alternatively, the object distance (S_{Object}) is large. Each path represents a design trade-off. In most elliptical systems, a divergent beam leaves the aperture, which means increasing the object distance increases the size of the lens or causes overfill of the lens and a resulting loss in efficiency. On the other hand, shrinking the object size means the light from the source is sent through a smaller aperture. Because of the conservation of Etendue shrinking, the area increases in illumination beam angle, which increases the lens size, or reduces collection efficiency. All other thing being equal, reducing the beam angle places an increased demand on the illumination system Etendue. As such, it becomes increasingly important to design using low Etendue sources (e.g., less than 400 mm²·sr) and illumination optics that provide the beam characteristics desired at the aperture while minimizing growth in Etendue.

A trend in beam projection systems has been to use elliptical reflectors for higher collection efficiency that results in higher spot brightness for a given source. With continued reference to FIG. 1A, and denoting a, b, and c as the major axis, minor axis, and focus of the ellipse, the overall optical system length is given by:

Optical Axis Length=S_{Object}+2a−c+Adjuster

where Adjuster is the length (not shown explicitly) needed at the back of the reflector to allow mounting and adjustment of the light source in the reflector.

TABLE 1A
Elliptical Reflector Parameters

| | Aspect Ratio | | | | | | | | |
|---|---|---|---|---|---|---|---|---|---|
| | 1 | 1.2 | 1.4 | 1.6 | 1.8 | 2 | 2.5 | 3 | 3.5 |
| Major Axis | 1 | 1 | 1 | 1 | 1 | 1 | 1 | 1 | 1 |
| Minor Axis | 1 | 0.83 | 0.71 | 0.63 | 0.56 | 0.5 | 0.4 | 0.33 | 0.29 |
| Focus | 0 | 0.55 | 0.7 | 0.78 | 0.83 | 0.87 | 0.92 | 0.94 | 0.96 |
| Collected Angle | 90 | 56 | 46 | 39 | 34 | 30 | 24 | 19 | 17 |
| Focus Separation | 0 | 1.11 | 1.4 | 1.56 | 1.66 | 1.73 | 1.83 | 1.89 | 1.92 |
| Arc-Reflector Separation | 1 | 0.45 | 0.3 | 0.22 | 0.17 | 0.13 | 0.08 | 0.06 | 0.04 |

Table 1A, above, shows the focus, collected angle, and focus separation for an ideal half-ellipsoid reflector with a unit major axis dimension. To achieve a compact system, it would be advantageous to have a small elliptical reflector. However, the small elliptical reflector is not practical due to the physical extent of the source and the need for clearance between the reflector and the bulb. The physical extent of the light source is driven by the arc gap (mm) and the wall loading (W/mm²). The permissible wall loading depends on the bulb materials, the fill chemistry, and a desired life expectancy. In general, the rare earth metals are more efficacious and deliver a higher color quality. Thus, the rare earth metals are desirable for illumination applications where color rendering is critical. On the other hand, rare earth metals are more chemically active and so, for the same life, require larger arc gaps and lower wall loadings.

FIG. 1C shows the construction of a typical prior art discharge lamp used in the industry. Even at relatively low wattages (e.g., 400 W), the bulb width “d” might be 15 mm and the bulb length “l₂” might be 30 mm. A 400 W light source delivers about 30,000 lumens and requires about a 20 mm clearance from the arc to the inside wall of the elliptical reflector.

Looking at the arc-reflector separation parameter in Table 1A and assuming a discharge lamp that needs 20 mm of clearance from the arc to the reflector, the appropriate practical reflector sizes can be calculated as shown in Table 1B.

TABLE 1B
Elliptical Reflector Parameters
Scaled for a 20 mm Arc-Reflector Clearance

| | Aspect Ratio | | | | | | | | |
|---|---|---|---|---|---|---|---|---|---|
| | 1 | 1.2 | 1.4 | 1.6 | 1.8 | 2 | 2.5 | 3 | 3.5 |
| Collected | 90 | 56 | 46 | 39 | 34 | 30 | 24 | 19 | 17 |
| Angle | | | | | | | | | |
| Major Axis | 20 | 45 | 67 | 91 | 119 | 149 | 240 | 350 | 480 |
| Dimension | | | | | | | | | |
| Minor Axis | 20 | 37 | 48 | 57 | 66 | 75 | 96 | 117 | 137 |
| Dimension | | | | | | | | | |
| Focus | 0 | 25 | 47 | 71 | 99 | 129 | 220 | 330 | 460 |
| Focus - Focus | 0 | 49 | 93 | 142 | 197 | 259 | 439 | 659 | 920 |
| Separation | | | | | | | | | |

Increasing the aspect ratio of the reflector has a beneficial effect of delivering a tighter ray bundle into the aperture at the expense of a larger overall size. FIG. 1D illustrates this design tradeoff. It can be seen that as the aspect ratio goes above 2, the separation of foci grows rapidly which in turns drives the length of the overall system.

The absolute collection efficiency of the system depends on the source Etendue, the collection optic design, the aperture size, the lens's size, and the beam angle. The following table shows some example systems using conventional discharge lamp technology.

TABLE 2
Example Performance of Several Image Projection Systems

| | Fixed | Moving | Follow |
|---|---|---|---|
| | Spot | Head | Spot |
| Source Wattage (W) | 150 | 400 | 2,500 |
| Source Etendue | High | Med | Low |
| Source Output | 15,000 | 26,000 | 240,000 |
| Elliptical reflector (mm): | 150 | 100 | Condenser |
| Aperture size (mm): | 75 | 25 | 15 |
| Lens Size (mm): | 150 | 70-100 | 200-300 |
| Overall Length (mm): | 500 | 375 | 1,250 |
| Collection Efficiency (%): | 60 | 35 | 13 |
| Output (Lumens): | 9,000 | 7,000 | 30,000 |

Table 2, above, identifies three general types of system, each with different illumination needs. Although there are overlaps in categories of the systems, the three general types of systems are characterized in accordance with the following explanations.

### Fixed Spot Systems

A fixed spot system is generally characterized as an image projection system with an image beam angle of 15° to 35°. In these systems, the primary function of the illumination optics is to create a uniform beam with high efficiency in a compact package. A common product in this category is the Source Four® family of fixed spots from Entertainment Theater Controls (headquartered at Middleton, Wis., USA). These products use tungsten incandescent (500 W-1000 W) and discharge lamps (75 W-150 W). A common system delivers 5,000-12,000 lumens with an optical efficiency of 50%-65%. The system has an efficacy of 16 lumens per watt (LPW) and an overall system length of 500 mm-600 mm. Table 3A, below, summarizes several products in the Source Four® family.

TABLE 3A
Characteristics for a Fixed Spot Family of Products

| | | | Initial | | Optical | | |
|---|---|---|---|---|---|---|---|
| | Lamp | | Beam | System | System | | Beam |
| | Wattage | Lamp | Lumens | Efficacy | Length | Efficiency | Angle |
| Product Name | (Watts) | Type | (Lumens) | (LPW) | (mm) | (%) | (°) |
| Source Four ® 5 | 750 | Tungsten | 7520 | 12.5 | 959 | 42.8 | 5 |
| Source Four ® 10 | 750 | Tungsten | 8615 | 15.9 | 732 | 54.5 | 10 |
| Source Four ® 19 | 750 | Tungsten | 11,180 | 15 | 545 | 51% | 19 |
| Source Four ® 26 | 750 | Tungsten | 13,690 | 18 | 545 | 63% | 26 |
| Source Four ® 36 | 550 | Tungsten | 10,510 | 19 | 545 | 65% | 36 |
| Source Four ® 50 | 750 | Tungsten | 13,980 | 19 | 545 | 63% | 50 |
| Source Four ® 70 | 750 | Tungsten | 9,595 | 22 | 503 | 74% | 70 |
| Source Four ® 90 | 750 | Tungsten | 8,555 | 18 | 478 | 60% | 90 |

### Moving Head Profile Systems

A moving head profile system is different from a fixed spot system in three important ways. Firstly, in a moving head system, the optical subassembly spins and rotates on a yoke. This makes it important to balance the optical subsystem and to keep the moment of inertia low. Secondly, because these systems are dynamic, they typically use a variable zoom and focus lens. This more complex lens means that the object distance to the first lens element can be shorter than in a typical fixed spot system. Thirdly, the moving head system employs many effects. These effects are typically placed in the convergent illumination beam between the elliptical reflector and the aperture. For this reason, the illumination system of a moving head is typically designed with a relatively long separation between the first focus and the second focus to allow placement of the effects hardware. A common product in this category is the MAC family of moving heads from Martin Professional (headquartered at Arhus, Denmark). These products use short arc metal halide lamps (150 W-1500 W). A common system delivers 5,000-30,000 lumens with an optical efficiency of 20%-38%, a system efficacy of 15-22 lumens per watt, and an overall optical system length of 500 mm-600 mm. Table 3B, below, summarizes several products in this family.

TABLE 3B
Characteristics for a Moving Head Profile Family of Products

| | | | Initial | | Optical | | |
|---|---|---|---|---|---|---|---|
| | Lamp | | Beam | System | System | | Beam |
| | Wattage | Lamp | Lumens | Efficacy | Length | Efficiency | Angle |
| Product Name | (Watts) | Type | (Lumens) | (LPW) | (mm) | (%) | (°) |
| MAC Profile 250 | 250 | HTI | 5,000 | 18 | 375 | 28% | 20 |
| MAC Profile 700 | 700 | HTI | 16,000 | 20 | 450 | 30% | 20 |
| MAC Profile III | 1,500 | HTI | 33,000 | 19 | 690 | 23% | 34 |

### Follow Spot System

A follow spot system is generally characterized as a blend of the fixed spot and moving head profile systems. Follow spots are dynamic. The optical system is mounted on a tripod and an operator directs the beam to follow a performer or some other object of interest. In some designs, these systems have a small image beam angle. The small image beam angle presents particular challenges in terms of source Etendue and collection efficiency. To provide the needed lumens in a small Etendue, these systems use short arc discharge lamps. Also, because the beam angle is small, the object distance tends to be long and the imaging lenses tend to be large. These factors increase the cost of low beam angle follow spots.

TABLE 3C
Characteristics for a Follow Spot Family of Products

| | | | | | Optical | | |
|---|---|---|---|---|---|---|---|
| | Lamp | | Initial Beam | System | System | | Beam |
| | Wattage | Lamp | Lumens | Efficacy | Length | Efficiency | Angle |
| Product Name | (Watts) | Type | (Lumens) | (LPW) | (mm) | (%) | (°) |
| Robert Juliat Topaze | 1,200 | HMI | 16,000 | 13 | 1,150 | 17% | 7 |
| Robert Juliat Manon | 1,200 | MSD | 25,000 | 21 | 900 | 27% | 13 |
| Robert Juliat Manon | 1,200 | MSD | 29,000 | 24 | 900 | 32% | 23 |

### BRIEF DESCRIPTION OF THE DRAWINGS

Novel features of the invention are set forth with particularity in the appended claims. A better understanding of features and advantages of the present invention are obtained by reference to the following detailed description that sets forth illustrative embodiments.

FIG. 1A is a schematic view of an elliptical reflector-based image projection system of the prior art;

FIG. 1B is a schematic view of a condenser lens-based image projection system of the prior art;

FIG. 1C is a line drawing of an electrode discharge lamp of the prior art;

FIG. 1D is a plot showing collected angle and major axis dimension as a function of aspect ratio for an elliptical reflector of the prior art;

FIG. 2 is a schematic layout of an example embodiment showing at least certain aspects of the inventive subject matter;

FIG. 3A is a cross-section and schematic view of a directional light source according to an example embodiment;

FIG. 3B shows an example lamp body used to couple power into the bulb of the directional light source according to an example embodiment;

FIG. 3C is a schematic diagram of a drive system used to power and control the directional light source according to an example embodiment;

FIG. 3D is an example of a spatial distribution of intensity from the directional light source of FIG. 3A;

FIG. 3E is an example of an angular distribution of intensity from the directional light source of FIG. 3A;

FIG. 3F is an example of a spatial distribution of color temperature from the directional light source of FIG. 3A;

FIG. 3G is an example of an angular distribution of color temperature from the directional light source of FIG. 3A;

FIG. 3H is an example of a spectrum from the directional light source of FIG. 3A;

FIG. 3I is an example of a Lumen-Etendue curve from the directional light source of FIG. 3A;

FIG. 4A shows an example embodiment of a non-imaging optic;

FIG. 4B shows an example input area to exit area mapping of the example non-imaging optic of FIG. 4A;

FIG. 5A shows an example embodiment of a directional light source non-imaging optic system with an input radius of 6.5 mm, an exit radius of 33 mm, and an exit f-number of 2.5;

FIGS. 5B, 5C, and 5D show non-imaging optic exit beam characteristics for the directional light source non-imaging optic system of FIG. 5A;

FIG. 6A shows an example embodiment of a directional light source non-imaging optic system with an input radius of 6.5 mm, an exit radius aperture of 28 mm, and an exit f-number of 1.5;

FIGS. 6B, 6C, and 6D show non-imaging optic exit beam characteristics for the directional light source non-imaging optic system of FIG. 6A;

FIG. 7A shows an example embodiment of a directional light source non-imaging optic system with an input radius of 6.5 mm, an exit radius of 20 mm, and an exit f-number of 1.5;

FIGS. 7B, 7C, and 7D show non-imaging optic exit beam characteristics for the directional light source non-imaging optic system of FIG. 7A;

FIGS. 7E, 7F, 7G, and 7H show exit beam characteristics for a Lambertian source connected to a compound parabolic collector (CPC);

FIG. 8A shows an example embodiment of a directional light source non-imaging optic system with an input radius of 4.0 mm, an exit radius of 20 mm, and an exit f-number of 1.5;

FIGS. 8B, 8C, and 8D show non-imaging optic exit beam characteristics for the directional light source non-imaging optic system of FIG. 8A;

FIG. 9A shows an example embodiment of a 6° image beam angle design with a directional light source and a truncated, f/2.5 non-imaging optic system;

FIGS. 9B, 9C, and 9D show non-imaging optic exit beam characteristics for the directional light source, truncated non-imaging optic system of FIG. 9A;

FIG. 9E shows an example embodiment of a 6° image beam angle design with a directional light source and a full length, f/1.5 non-imaging optic system;

FIGS. 9F, 9G, and 9H show non-imaging optic exit beam characteristics for the directional light source, full length non-imaging optic system of FIG. 9E;

FIG. 91 shows an example embodiment of a 6° image beam angle design with a directional light source and a full length, f/2.5 non-imaging optic system

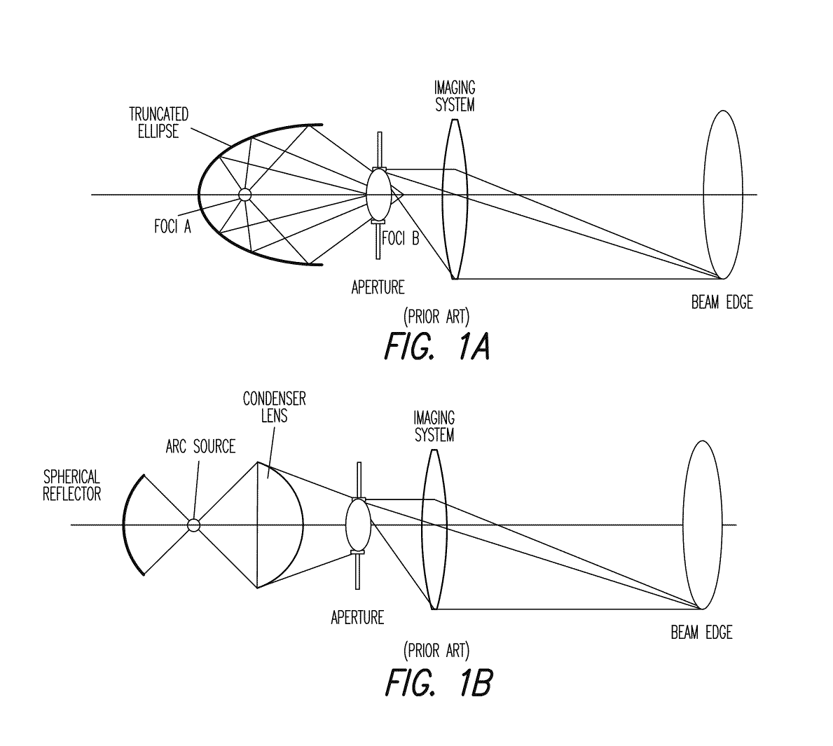

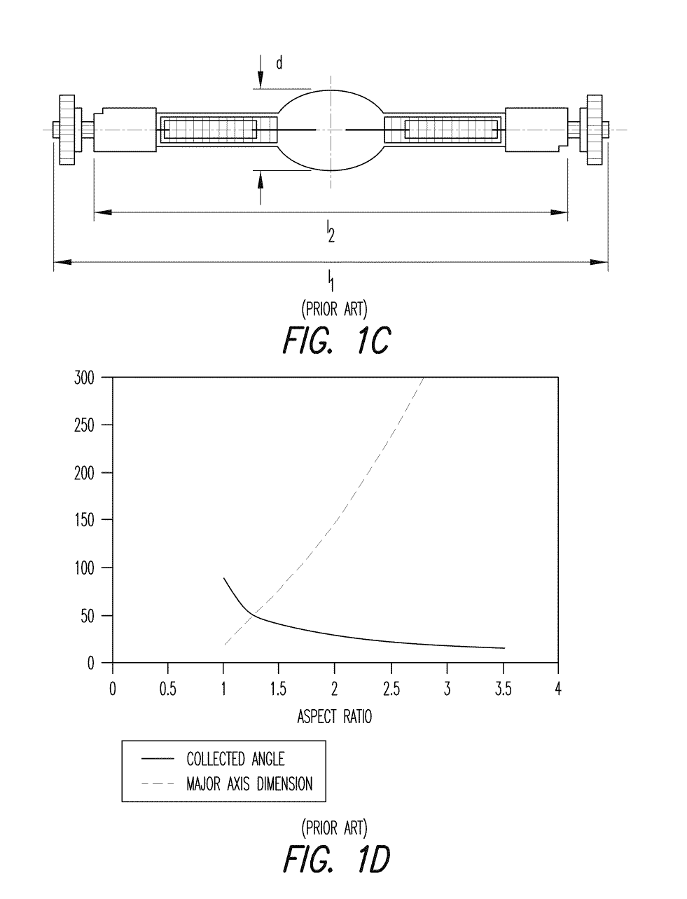

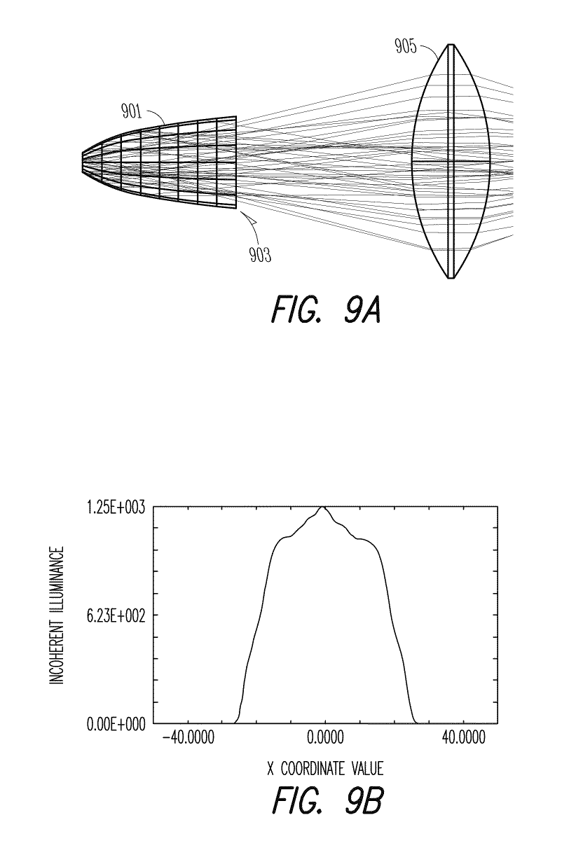

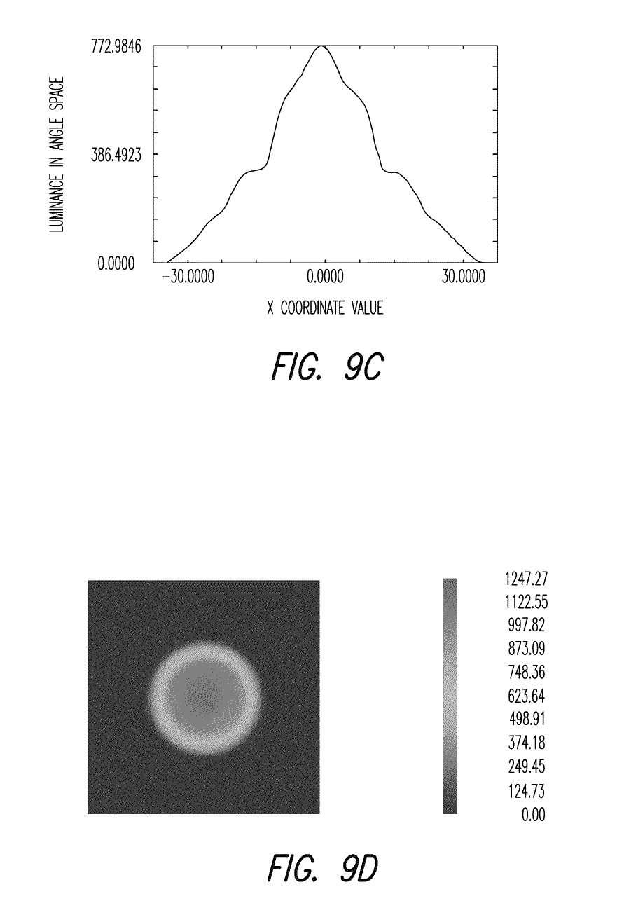

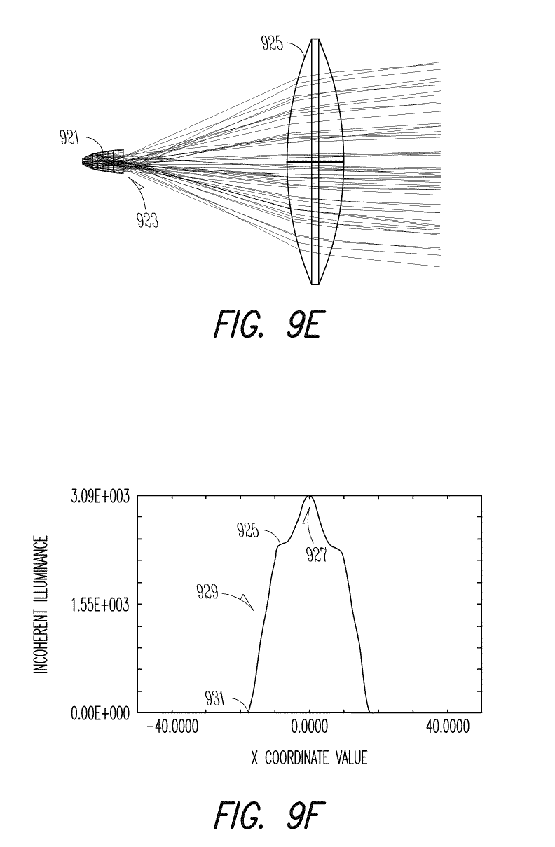

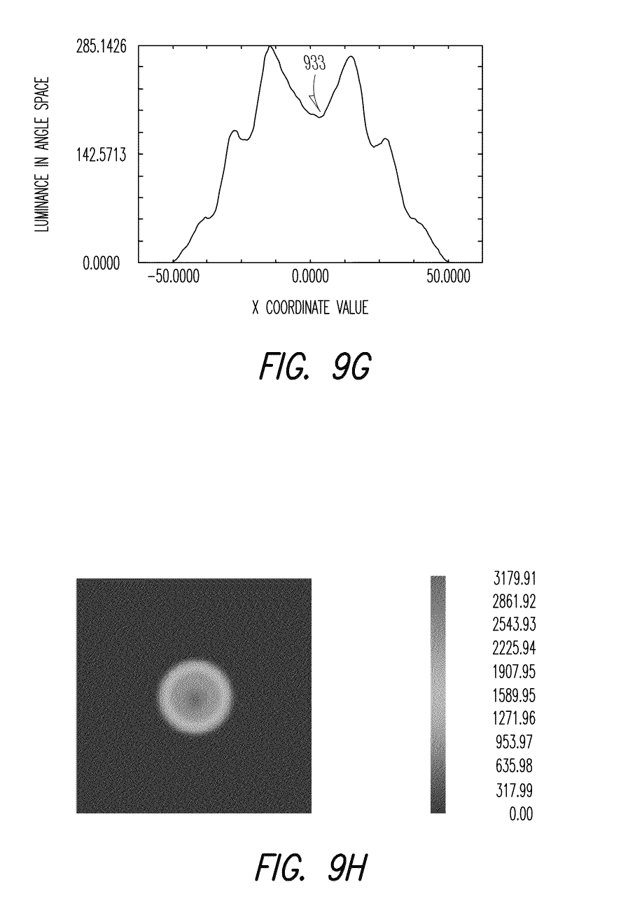

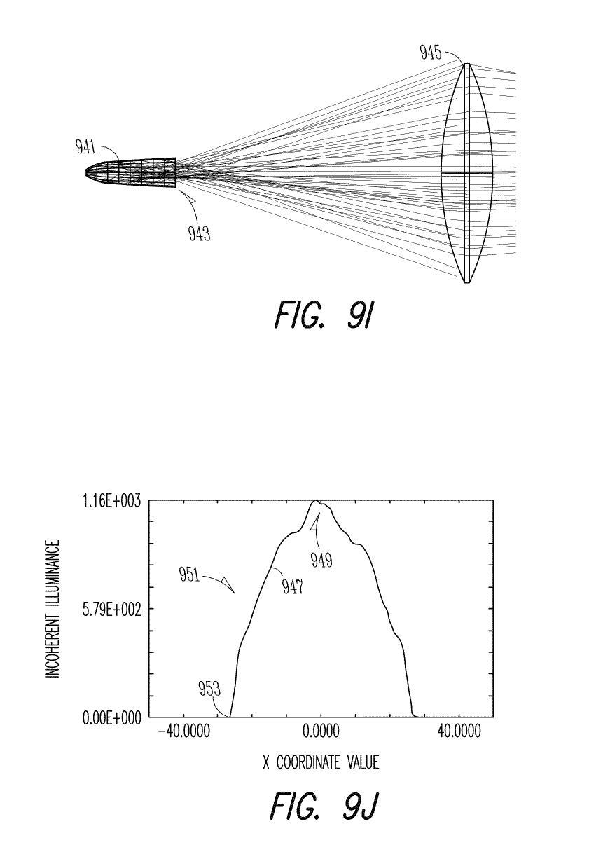

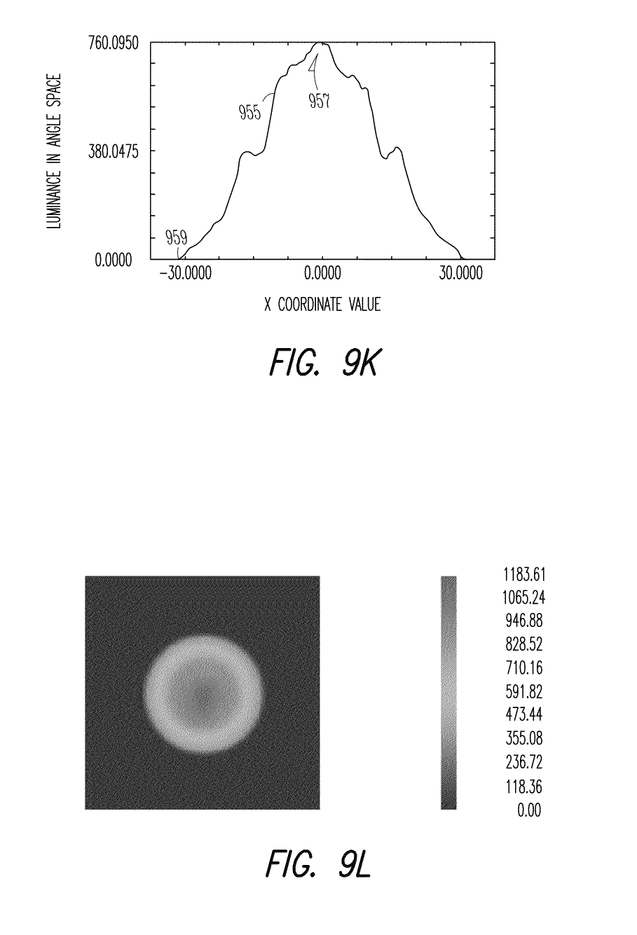

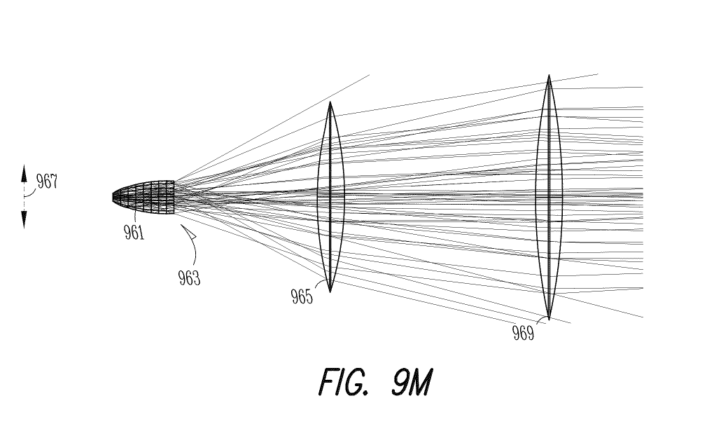

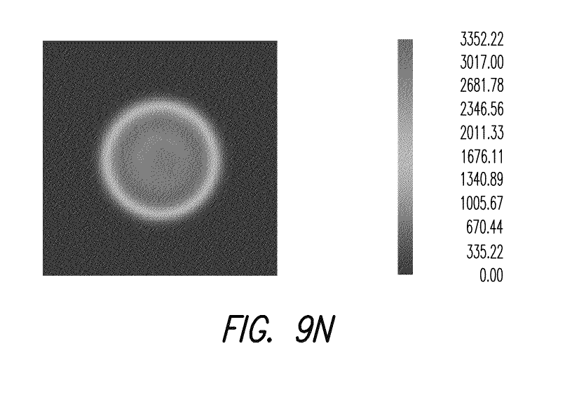

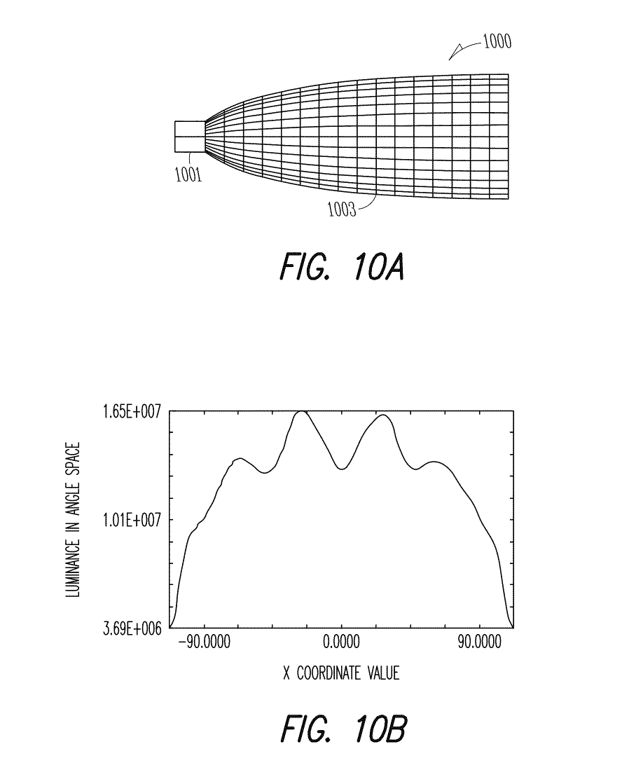

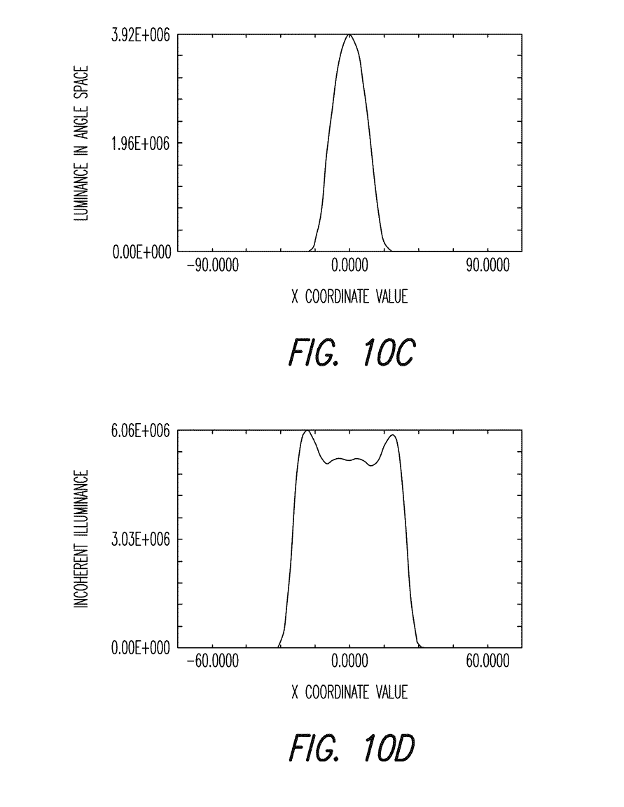

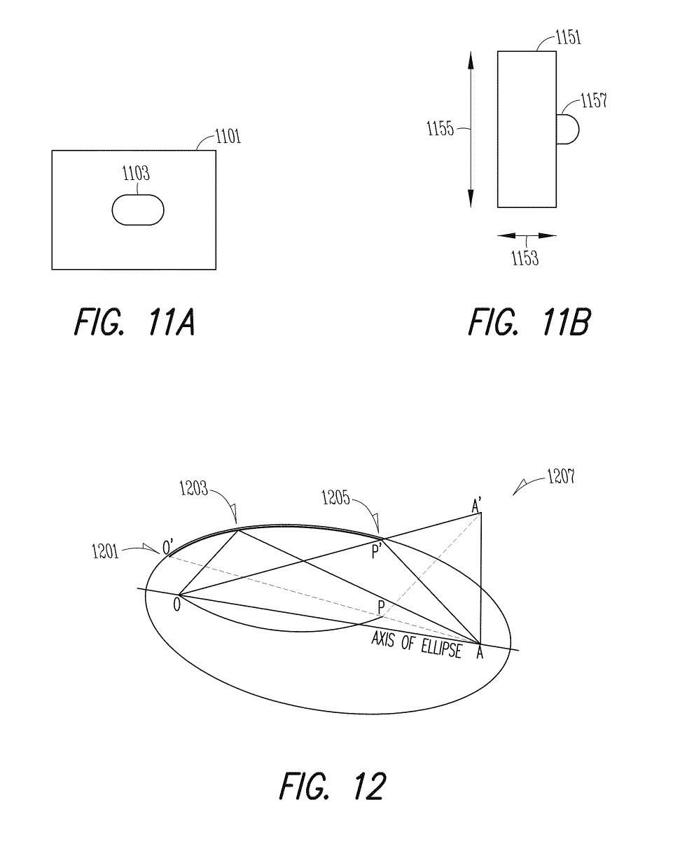

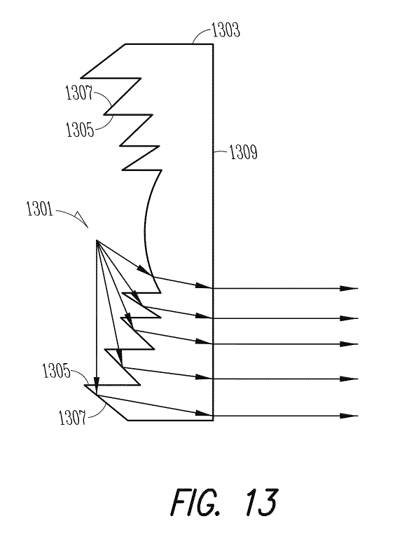

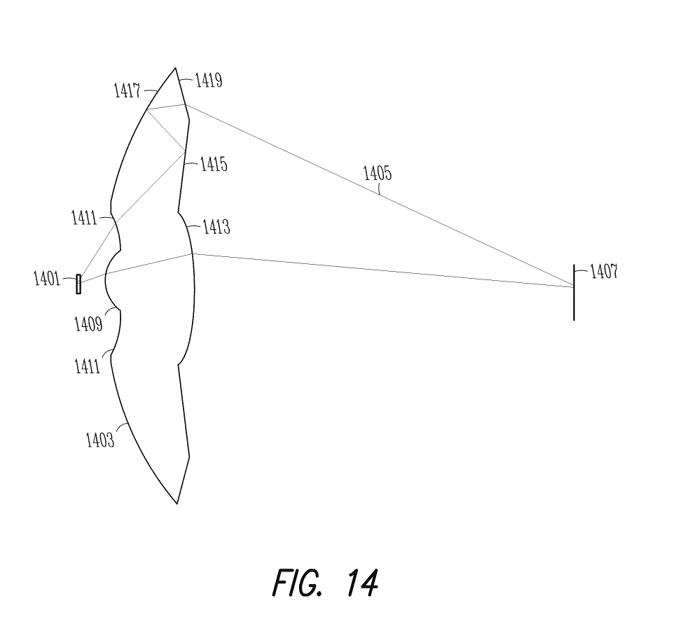

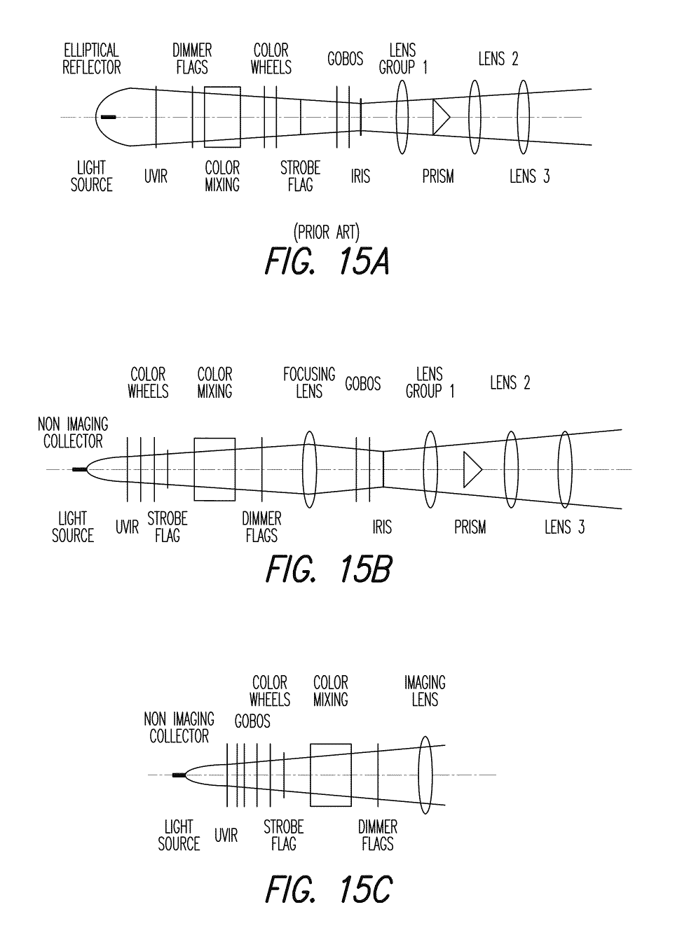

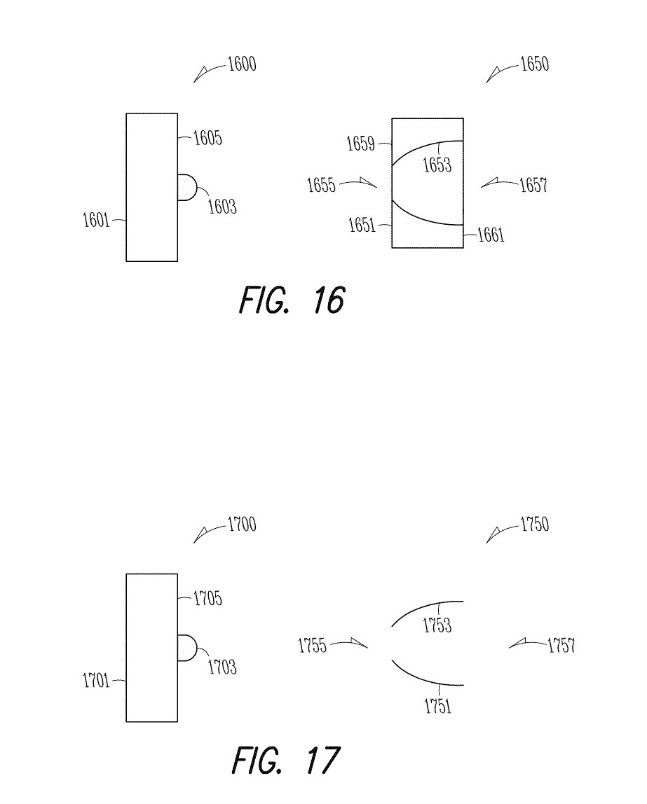

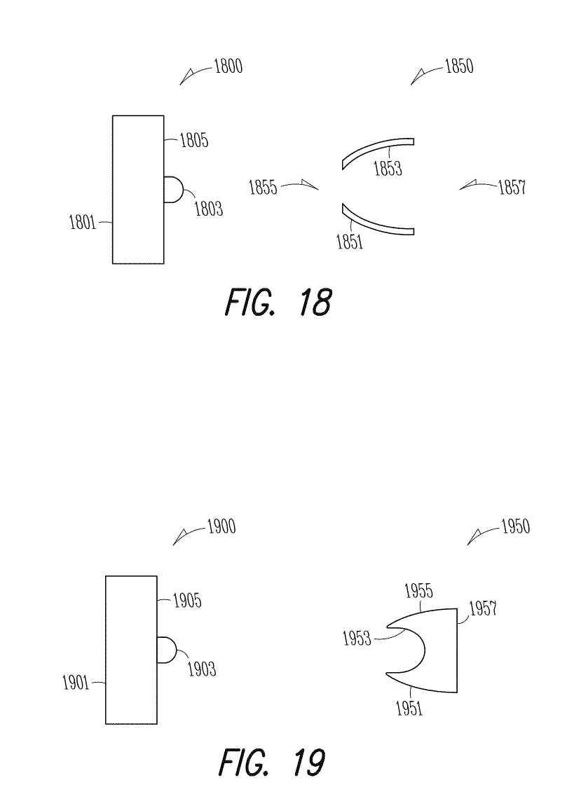

FIGS. 9J, 9K, and 9L show non-imaging optic exit beam characteristics for the directional light source, full length non-imaging optic system of FIG. 91;

FIG. 9M shows an example embodiment of a 6° image beam angle design with a directional light source, a full length, f/1.5 non-imaging optic system and a twin lens imaging system.

FIG. 9N shows a spatial distribution of the exit beam for the directional light source, full length non-imaging optic and twin lens imaging system of FIG. 9M;

FIG. 10A shows an example embodiment of a two stage non-imaging optic where a first-stage acts as a homogenizer;

FIG. 10B shows an angular distribution at the exit face of the first homogenizer stage;

FIGS. 10C and 10D show non-imaging optic exit beam characteristics for the two stage non-imaging optic system of FIG. 10A;

FIG. 11A shows an example embodiment of a directional light source where the exit section of the bulb is not circular;

FIG. 11B shows an example embodiment of the directional light source where the z-axis dimension of the light source is short with respect to the diameter of the light source;

FIG. 12 shows an example embodiment of a non-imaging optic where the reflective surface is elliptical;

FIG. 13 shows an example embodiment of a non-imaging optic where the beam is created using a Fresnel mirror or total internal reflection (TIR) lens approach;

FIG. 14 shows an example embodiment of a non-imaging optic where the beam is created using a reflection and refraction;

FIG. 15A is a schematic layout of an optical train in a conventional moving head system of the prior art;

FIG. 15B is a schematic layout of an optical train in an example embodiment where a refocusing lens is used to converge the beam from a non-imaging optic into an aperture;

FIG. 15C is a schematic layout of the optical train in an example embodiment where the gobos are placed at the exit of the aperture and the color management is in the divergent beam;

FIG. 16 shows an example embodiment with a light source and a non-imaging optic;

FIG. 17 shows another example embodiment with a light source and a non-imaging optic;

FIG. 18 shows another example embodiment with a light source and a non-imaging optic; and

FIG. 19 shows another example embodiment with a light source and a non-imaging optic.

### SUMMARY OF THE INVENTION

Example embodiments described herein may increase a collection efficiency of a beam projection system for a given size and throughput, reduce the size of the image projection system for a given throughput and collection efficiency, reduce the acceptance angle of the imaging lens, improve the brightness uniformity of the resulting beam, improve the color uniformity of the resulting beam, further improve efficiency by dimming, or further enhance optical effects by providing strobing. An example embodiment may comprise a light source that delivers light in a forward pattern with an intensity above 50 MLux. The light source has a broadband spectrum with a color-rendering index above 50. A non-imaging optic changes the angular and spatial distributions of the light source to feed the aperture with a desired distribution. An aperture that defines the edge of the projected image.

In an example embodiment, a beam projection system is described that includes a lamp body formed from a dielectric material. A bulb, placed adjacent to the lamp body, has a fill that forms a plasma when RF power is coupled to the fill from the lamp body. An optical train is optically coupled to the bulb to transform light generated by the plasma. The optical train includes a non-imaging optical element, an aperture, and at least one imaging lens element.

In another example embodiment, a beam projection system is described that includes a directional light source. A non-imaging optical element is optically coupled to receive light emitted from the directional light source. An aperture, proximate to the non-imaging optical element, and at least one imaging lens, form an output beam from the emitted light.

In another example embodiment, a method of producing an image is described. The method includes producing a beam of light from a directional light source and directing the beam of light through a non-imaging optical element. A spatial and angular distribution of the beam of light is transformed a in the non-imaging optical element. An output beam is then formed from the transformed beam of light.

### DETAILED DESCRIPTION

While the present invention is open to various modifications and alternative constructions, the embodiments shown in the drawings are described herein as example embodiments.

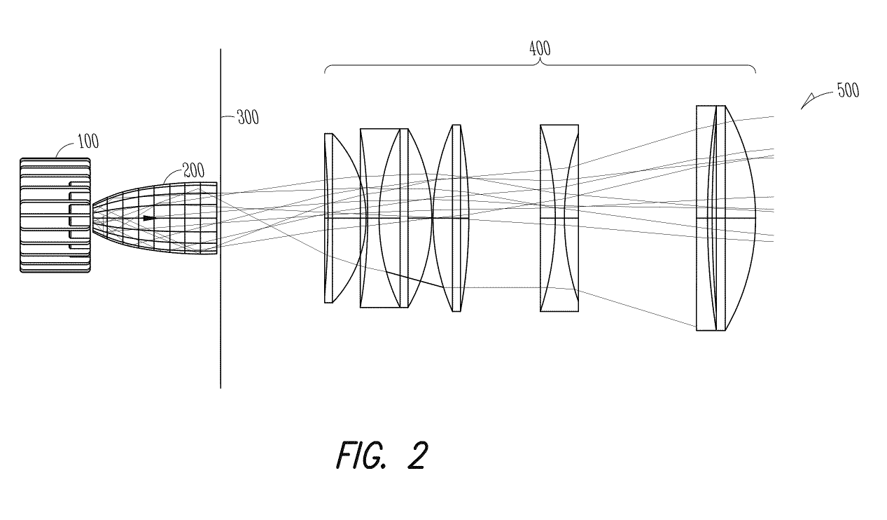

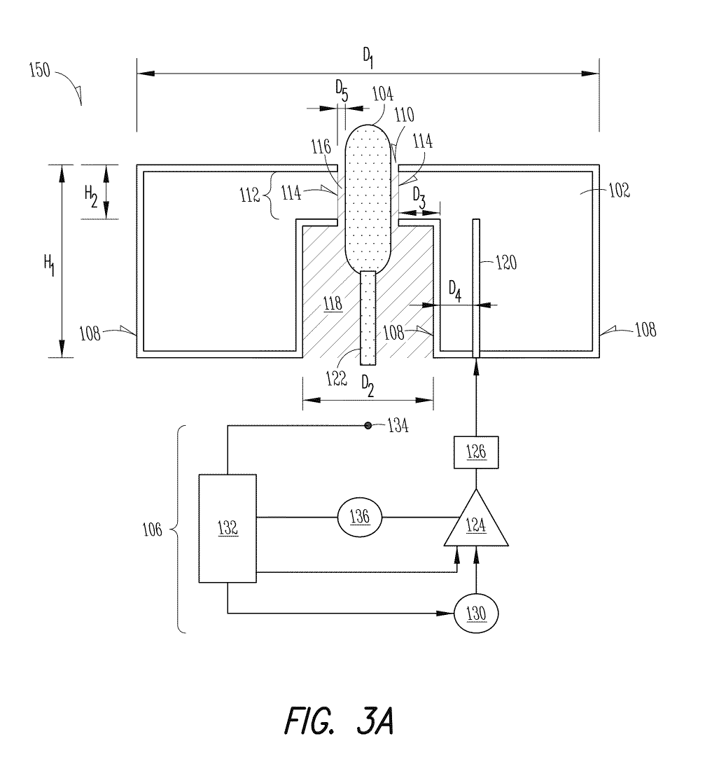

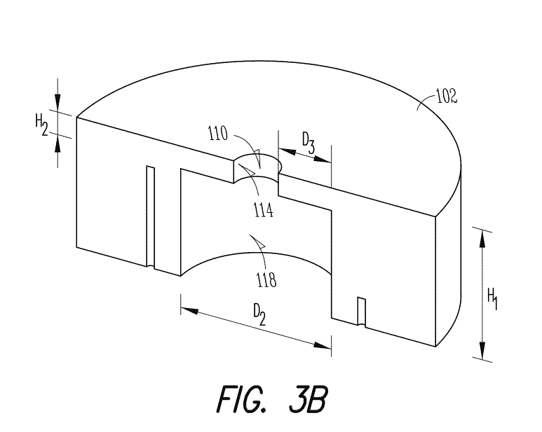

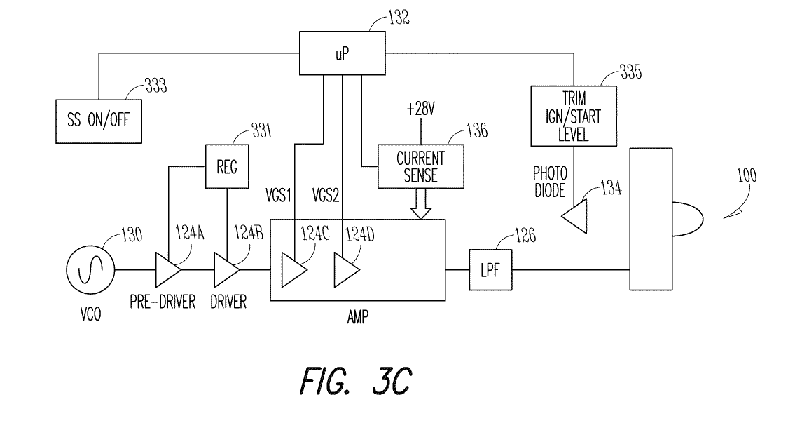

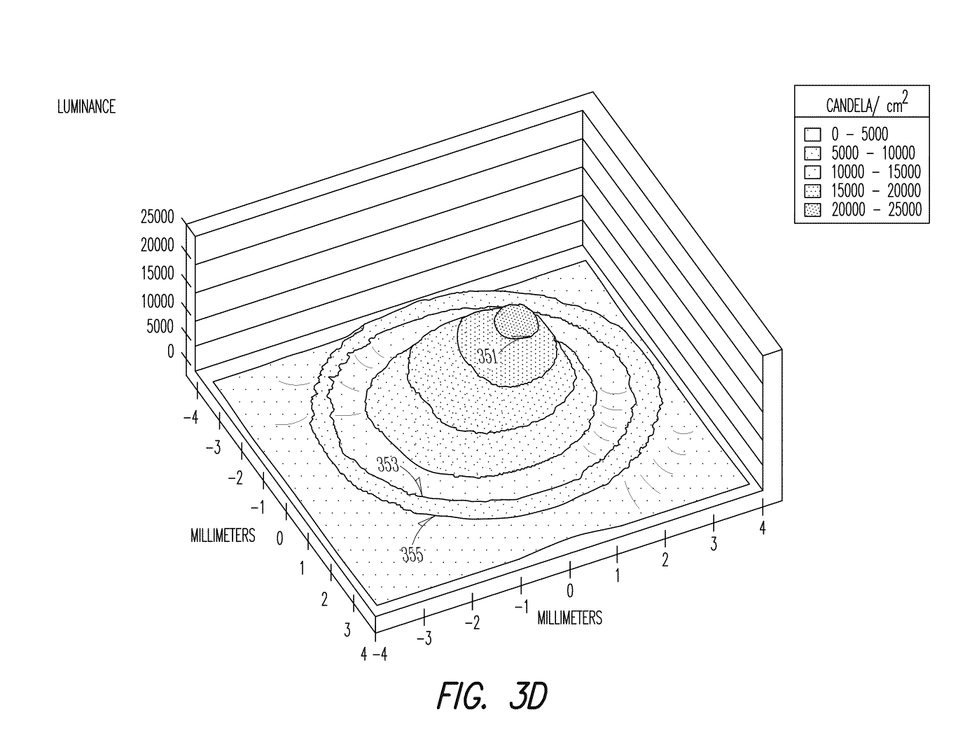

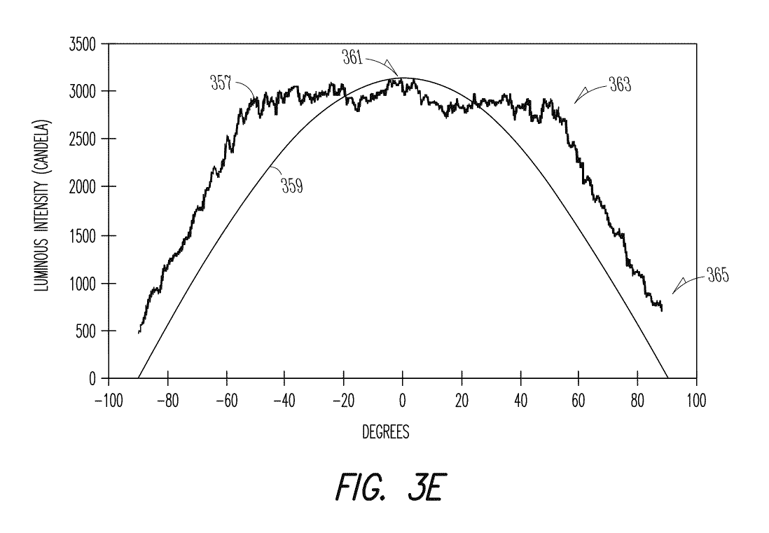

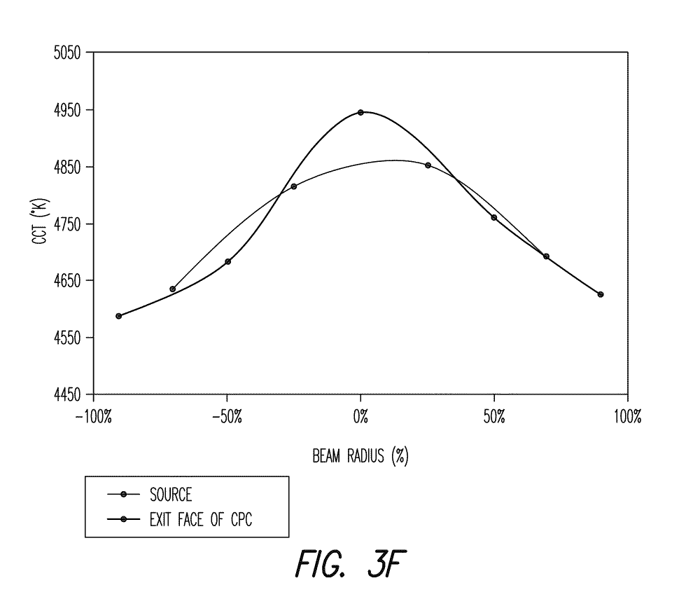

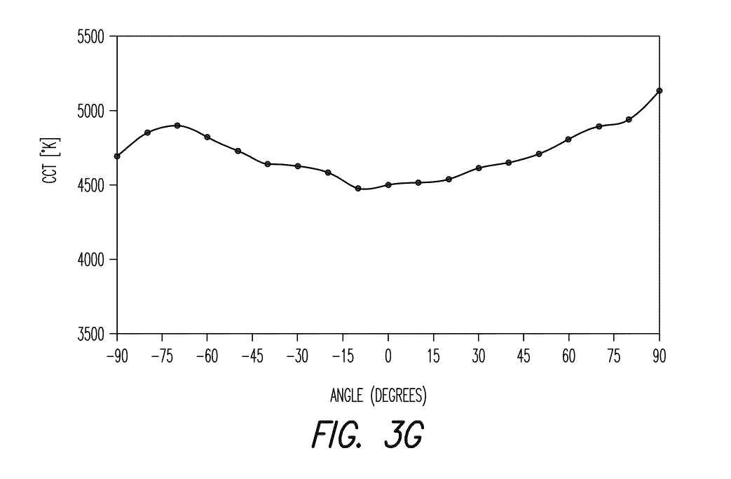

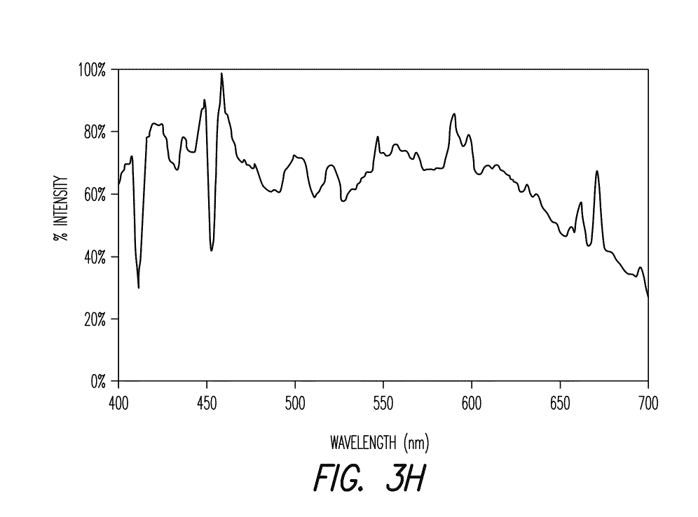

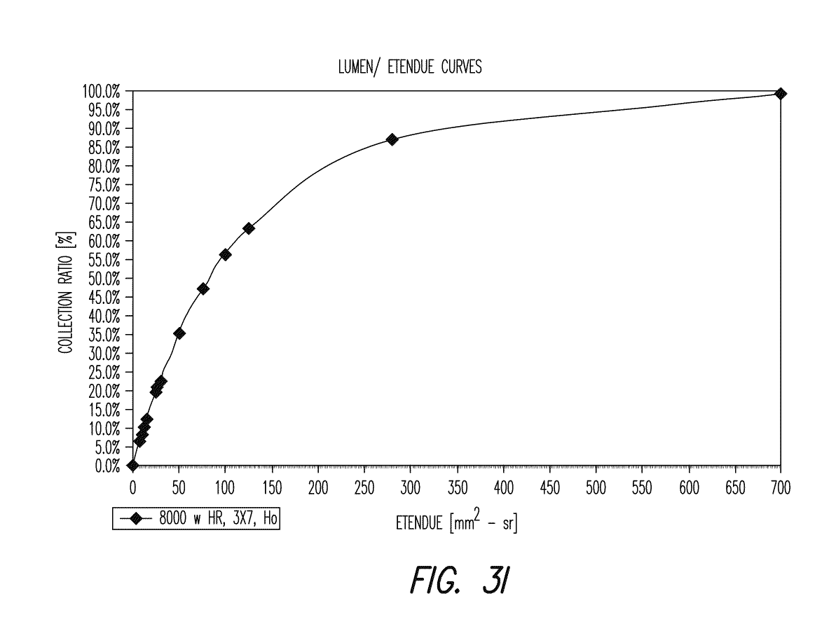

With reference to FIG. 2, a schematic layout of an example embodiment is shown to include a directional light source 100, a non-imaging optic 200 (also referred to herein as a NIO or non-imaging optical element), an aperture 300, an imaging lens 400, and a resulting projected beam 500. FIG. 3A is a cross-section and schematic view of a directional light source 150 according to another example embodiment. In a specific example embodiment, the directional light source may be the directional light source 100 of FIG. 2. In other example embodiments, the directional light source 150 may be used in the schematic layout shown in FIG. 2 or in any of the other beam projection and optical systems and layouts described herein. In the example of FIG. 3A, the directional light source may have a lamp body 102 formed from one or more solid dielectric materials and a bulb 104 positioned adjacent to the lamp body 102. The bulb 104 contains a fill that is capable of forming a light emitting plasma (not shown). A lamp drive circuit 106 couples radio frequency (RF) power into the lamp body 102 which, in turn, is coupled into the fill in the bulb 104 to form the light emitting plasma. In example embodiments, the radio frequency power may be provided at or near a frequency that resonates within the lamp body 102. This is an example only and some embodiments may use a different directional light source.

The directional light source 150 has a drive probe 120 inserted into the lamp body 102 to provide the radio frequency power to the lamp body 102. The lamp drive circuit 106 including a power supply, such as an amplifier 124, may be coupled to the drive probe 120 to provide the radio frequency power. The amplifier 124 may be coupled to the drive probe 120 through a matching network 126 to provide impedance matching. In an example embodiment, the lamp drive circuit 106 is matched to the load (formed by the lamp body 102, bulb 104, and plasma) for the steady state operating conditions of the lamp. The lamp drive circuit 106 is matched to the load at the drive probe 120 using the matching network 126.

The lamp body 102 defines a dimension along the optical axis from the light emitting area to the back of the lamp. In an example embodiment of the inventive subject matter, the lamp body 102 is designed to minimize this dimension and thereby reduce an overall length of the optical system.

### Bulb Power Source

In example embodiments, the radio frequency power may be provided at a frequency in the range of between about 50 MHz and about 10 GHz or any range subsumed therein. The radio frequency power may be provided to the drive probe 120 at or near a resonant frequency for the lamp body 102. The frequency may be selected based on the dimensions, shape, and relative permittivity of the lamp body 102 to provide resonance in the lamp body 102. In example embodiments, the frequency is selected for a fundamental resonant mode of the lamp body 102, although higher order modes may also be used in some embodiments.

### Bulb Materials

In some examples, the bulb 104 may be quartz, sapphire, ceramic, or another desired bulb material. A shape of the bulb 104 may be cylindrical, pill shaped, spherical, or another desired shape. In some embodiments, a layer of material 116, such as, for example, alumina powder, may be placed between the bulb 104 and the dielectric material of the lamp body 102 to manage thermal properties of the directional light source 150.

### Bulb Tail and Light Sensing

In some embodiments, the bulb 104 may have a tail 122 extending from one end of the bulb 104. In some example embodiments, the tail 122 may be used as a light pipe to sense a level of light in the bulb 104. The sensing of the light level may be used to determine ignition, peak brightness, or other state information regarding the bulb 104. Light detected through the tail 122 can also be used by the lamp drive circuit 106 for dimming and other control functions of the bulb 104. For example, as shown in FIG. 3A, the tail 122 extends from the bulb 104 to the back of the lamp proximate to a photodiode 134 or other photosensor. The photodiode 134 can sense light from the bulb 104 through the tail 122. The level of light can then be used by the lamp drive circuit 106 to control the lamp. The back of the lamp can be enclosed by a cover to avoid or minimize interference from external light from the surrounding environment. This isolates the region where light is detected by the photodiode 134 and helps avoid interference that might be present if light is detected from the front of the lamp.

### Bulb Geometry

In example embodiments, the bulb 104 may have an interior width or diameter in a range between about 2 mm and 30 mm or any range subsumed therein, a wall thickness in a range between about 0.5 mm and 4 mm or any range subsumed therein, and an interior length of between about 2 mm and 40 mm or any range subsumed therein. In example embodiments, an interior volume of the bulb 104 may range from 10 mm³ to 750 mm³ or any range subsumed therein. In some embodiments, the bulb volume is less than about 100 mm³. In example embodiments where power is provided during steady state operation at between about 150 to 200 watts, resulting in a power density in the range of about 1.5 watts per mm³ to 2 watts per mm³ (1500 to 2000 watts per cm³) or any range subsumed therein. In this example embodiment, the interior surface area of the bulb 104 is about 55.3 mm² (0.553 cm²) and the wall loading (power over interior surface area) is in the range of about 2.71 watts per mm² to 3.62 watts per mm² (271 to 362 watts per cm²) or any range subsumed therein. In some embodiments, the wall loading (power over interior surface area) may be 1 watt per mm² (100 watts per cm²) or more. These dimensions are examples only and other embodiments may use bulbs having different dimensions. For example, some embodiments may use power levels during steady state operation of 400 watts to 1 kilowatt or more, depending upon the target application. Referring to the bulb dimensions above and accounting for the fact that the lamp body 102 acts with the bulb 104 to create a forward direction light pattern, calculation of the nominal Etendue of the source as shown below.

Etendue is approximately equal to π times A, where A is the surface area of the outer surface of the bulb 104. Table 4A, below, shows the Etendue for a variety of bulb outer diameters.

TABLE 4A
Nominal Etendue for Sources with Protruding Bulbs

| | Bulb Radius | | | | | |
|---|---|---|---|---|---|---|
| | 2 | 2.5 | 3 | 3.5 | 4 | 5 |
| Bulb Protrusion | 3 | 3.5 | 4 | 4.5 | 5 | 6 |
| Nominal Etendue | 118 | 173 | 237 | 311 | 395 | 592 |

This example construction provides a light source with the Etendue needed for many beam projection systems including those with a low beam angle.

For example, with reference to FIG. 3I, an empirically measured Lumens-Etendue curve is shown for an example embodiment with a bulb radius of 3.5 mm. It can be seen that (88%) of the light is collected inside the nominal Etendue calculated above. A principle reason that rays fall outside the nominal Etendue is that some rays are not harvested directly from the surface of the bulb 104. These rays impinge on the puck surface (e.g., a surface of the lamp body 102) and are scattered into the forward beam resulting in increased Etendue.

The Lumens-Etendue curve of FIG. 3I, and in general, may be constructed using a projection technique where light rays in three-dimensional space are projected back onto a plane. The Etendue is then calculated by integrating the angular extent across the plane. This technique is appropriate in many conventional optics designs; however, the technique overstates the Etendue. As a result, by designing optics that account for the three-dimensional characteristic of the source, it is possible to achieve collection efficiencies that are higher than predicted in the above Lumens-Etendue model. In some example embodiments, a non-imaging optic is designed in this way.

In Table 4B, below, the Etendue of the protruding bulb system is compared with the Etendue of two Lambertian emitting disks: one in air and one in an air/glass mix. The first Lambertian disk represents a beam in the air space just above the exit face of a cylindrical bulb. The second disk represents a beam travelling along the length of a cylindrical bulb towards the exit face.

TABLE 4B
Nominal Etendue for Protruding Bulbs Compared
to Related Lambertian Disks

| | Bulb Radius | | | | | |
|---|---|---|---|---|---|---|
| | 2 | 2.5 | 3 | 3.5 | 4 | 5 |
| Bulb Protrusion | 3 | 3.5 | 4 | 4.5 | 5 | 6 |
| Bulb Wall Thickness | 1 | 1 | 2 | 2 | 2 | 2 |
| Protruding Bulb Etendue | 118 | 173 | 237 | 311 | 395 | 592 |
| Disk in Air Etendue | 39 | 62 | 89 | 121 | 158 | 247 |
| Disk in Air/Glass Etendue | 76 | 111 | 172 | 223 | 306 | 444 |

As can be seen from Table 4B, the beam exiting the protruding bulb has a larger Etendue than the beam travelling along the length of the bulb. This is because the bulb protrusion creates a three dimensional surface over which the ray bundle's angular extent needs to be integrated. In sample embodiments the bulb-exit surface area is modified to minimize the impact on Etendue.

Referring back now to FIG. 3D, the spatial distribution of the emitted light in this example embodiment is non-uniform. In particular there is a central hot spot 351, a lower brightness annulus 353, and a brighter outside ring 355. This spatial distribution does not increase the system Etendue, but it does affect the shape of the Lumens-Etendue curve. Specifically, the brighter outside ring 355 places rays in the upper portion of the Lumens-Etendue curve. In some examples, this means that if the source Etendue is too large for the application, the beam cannot be trimmed without a significant loss of light. The brighter outside ring 355 is caused by rays being light-piped up the wall of the bulb due to a total internal reflection (TIR) condition.

In an example embodiment, the TIR condition is broken and the brighter outside ring 355 is eliminated. This can be done by frosting the bulb inner diameter. The frosting may be accomplished by, for example, acid etching, mechanical abrasion, or laser ablation.

### Bulb Fill

In example embodiments, the bulb 104 contains a fill that forms a light emitting plasma when radio frequency power is received from the lamp body 102. The fill may include a noble gas and a metal halide. Additives such as Mercury may also be used. An ignition enhancer may also be used. A small amount of an inert radioactive emitter such as Krypton-85 (Kr85) may be used for this purpose. Some example embodiments may use a combination of metal halides to produce a desired spectrum and lifetime characteristics. In some example embodiments, the first metal halide is Aluminum Halide, Gallium Halide, Indium Halide, or Thallium Halide (or a combination of Aluminum Halide, Gallium Halide, Indium Halide, or Thallium Halide). In some example embodiments, the second metal halide is Holmium Halide, Erbium Halide, or Thulium Halide (or a combination of one or more of these metal halides). In these example embodiments, the first metal halide may be provided in a dose amount in the range of about 0.3 mg/cc to 3 mg/cc or any range subsumed therein and the second metal halide may be provided in a dose amount in the range of about 0.15 mg/cc to 1.5 mg/cc or any range subsumed therein. In some example embodiments, the first metal halide may be provided in a dose amount in the range of about 0.9 mg/cc to 1.5 mg/cc or any range subsumed therein and the second metal halide may be provided in a dose amount in the range of about 0.3 mg/cc to 1 mg/cc or any range subsumed therein. In some example embodiments, the first metal halide is provided in a larger dose amount than the second metal halide. These doses are examples only and other embodiments may use other fills.

### Low Noise Source

The plasma arc produced in example embodiments may be stable with low noise. Power is coupled symmetrically into the center region of the bulb 104 from the lamp body 102 and is not disturbed by electrodes in the bulb 104 (or degradation of those electrodes).

### Dimming

The lamp can also be dimmed to low light levels less than 10%, 5%, or 1% of peak brightness or even less in some embodiments. In some embodiments, upon receiving the dimming command, a drive circuit of FIG. 3C is shown to include a microprocessor 132 that can control Vgs1 and Vgs2 to adjust the gain of a first amplifier 124C and a second amplifier 124D to dim the directional light source 100. The microprocessor 132 also continues to make small adjustments in frequency to optimize the frequency for the new target light output level.

### Pulse Width Modulation for Dimming

In an alternative example embodiment, the lamp can be dimmed using pulse width modulation. The power may be pulsed on and off at high frequency at different duty cycles to achieve dimming. For example, in some example embodiments, pulse width modulation may occur at a frequency of 1 kHz to 1000 kHz or any range subsumed therein. In one example, a pulsing frequency of about 10 kHz is used. The 10 kHz pulsing frequency provides a period of about 0.1 milliseconds (100 microseconds). In another example, a pulsing frequency of about 500 kHz is used. The 500 kHz pulsing frequency provides a period of about 2 microseconds. In other examples, the period may range from about 1 millisecond (at 1 kHz) to 1 microsecond (at 1000 kHz) or any range subsumed therein. However, the plasma response time is slower, so the pulse width modulation does not turn the lamp off. Rather, the average power to the lamp can be reduced by turning the power off during a portion of the period according to a duty cycle. For example, the microprocessor 132 may turn off a voltage-controlled oscillator (VCO) 130 during a portion of the period to lower an average power provided to the lamp. Alternatively, an attenuator may be used between the VCO 130 and the first amplifier 124C and the second amplifier 124D to turn off the power. In other embodiments, the microprocessor 132 may switch on and off one of the low-power gain stages of the multi-stage amplifier (comprising, e.g., a pre-driver 124A, a driver 124B, the first amplifier 124C, and the second amplifier 124D). For example, the microprocessor 132 may switch on and off the pre-driver 124A. In an example embodiment, if the duty cycle is 50%, the power is off half of the time and the average power to the lamp is cut in half (resulting in dimming of the lamp).

### Spread Spectrum

In some embodiments, the drive circuit also includes a spread spectrum mode to reduce electro-magnetic interference (EMI). The spread spectrum mode is turned on by an SS controller 333. When spread spectrum is turned on, a signal to the VCO 130 is modulated to spread the power provided by the drive circuit over a larger bandwidth. This can reduce EMI at any one frequency and thereby help with compliance with, for example, Federal Communications Commission (FCC, a United States regulatory agency) regulations regarding EMI. In example embodiments, the degree of spectral spreading may be from 5% to 30% or any range subsumed therein. In example embodiments, the modulation of the phase shifted by the VCO 130 can be provided at a level that is effective in reducing EMI without any significant impact on the plasma in the bulb.

The above dimensions, shape, materials, and operating parameters are examples only and other embodiments may use different dimensions, shape, materials, and operating parameters.

### Light Recycling

With reference again to FIG. 3A, in some example embodiments the bulb 104 may be embedded in a reflective powder. The powder serves many functions, but from an optical viewpoint it ensures that light exits the bulb 104 predominantly in a forward direction. Recirculating light through the bulb 104 homogenizes the source color and broadens the color spectrum.

FIG. 3F shows an example of the spatial color variation for the directional light source 100. The spatial distribution shows a high temperature core (4900° K.) surrounded by a lower temperature mantel (4400° K.). This compares favorably to some electroded lamps where the core color temperature may be as high as 7000° K. with a mantel temperature of 4000° K. Low spatial color variation is desirable as in many applications it is desirable to have a spot with uniform color. FIG. 3G shows an example of the angular color variation for the directional light source 100. The color temperature variation with angle is approximately ±250° K. FIG. 3H shows an example spectrum for the directional light source 100 with recirculation. This broad spectrum has a Color Rendering Index of greater than 95, which is advantageous in many beam applications including entertainment and architectural lighting.

As the reflective powder is not a perfect reflector there is some loss with each reflection. As such, it is necessary to balance the benefits of recirculation against the impact in overall efficiency. To a first order, an objective is to achieve a desired homogenization with a minimum number of bounces.

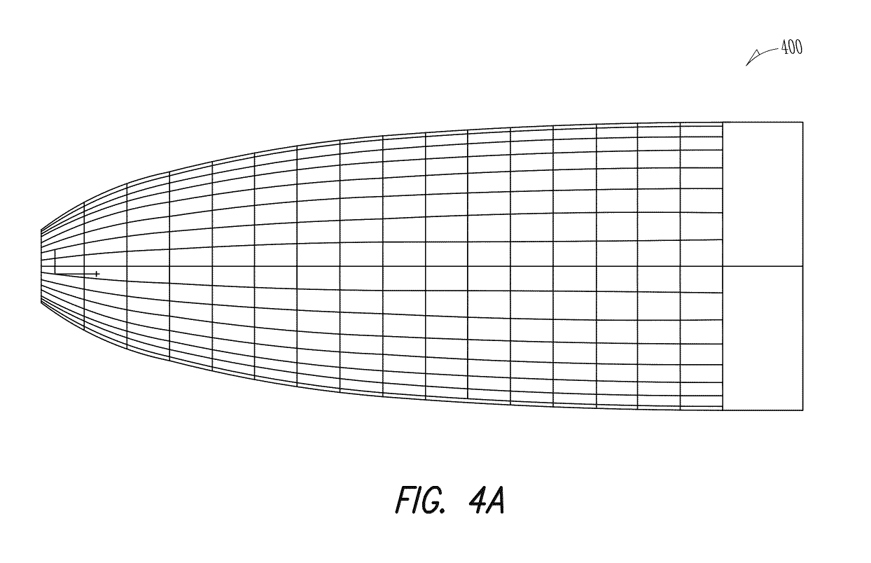

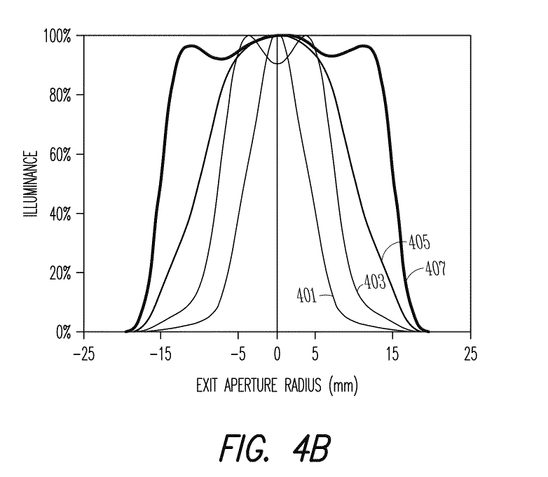

Referring now to FIG. 4A, an example embodiment of a non-imaging optic 400 is shown that may be used with the light source described, above, or other types of directional light sources. The directional light source feeds the non-imaging optic 400 that in turn transforms the spatial and angular distribution to deliver an exit beam matched to the application's needs. The spatial and angular distributions of the input beam are defined by the directional light source and a desired output beam size, brightness, and color uniformity are largely defined by the requirements of the final spot. An advantage of the non-imaging optic 400 (see also, for example, the non-imaging optic 200 of FIG. 2) is that it can be used to homogenize further color and brightness as shown with reference to FIG. 4B, below.

FIG. 4B shows an example embodiment of how ray bundles passing through an input aperture can be mapped to an exit aperture. It can be seen that the central rays at the input face are spread across the exit face. This homogenizing effect is important for improving color uniformity at the exit face. The various plots 401, 403, 405, and 407 show the spatial mapping from input face to exit face of 0.02 mm, 2 mm, 4 mm, and 8 mm diameter disks respectively. The spatial mapping plots relates to a compound parabolic reflector (CPC) with an input aperture diameter of 8 mm, an acceptance angle of 15°, and a length of 72.6 mm. Each of the input face disks are centered on the optical axis. It can be seen that the non-imaging optic spreads the central disks across a large area of the CPC exit face. This homogenizes hotspots in the light source creating a more uniform spatial and color distribution at the exit face. The combination of homogenization by recirculation and homogenization in the non-imaging optic allows a beam to be formed with high efficiency (e.g., greater than 70%), low brightness variation (e.g., less than 1.0), and excellent color uniformity (e.g., less than 200° K.).

The above dimensions, shape, materials, and operating parameters are examples only and other embodiments may use different dimensions, shape, materials, and operating parameters.

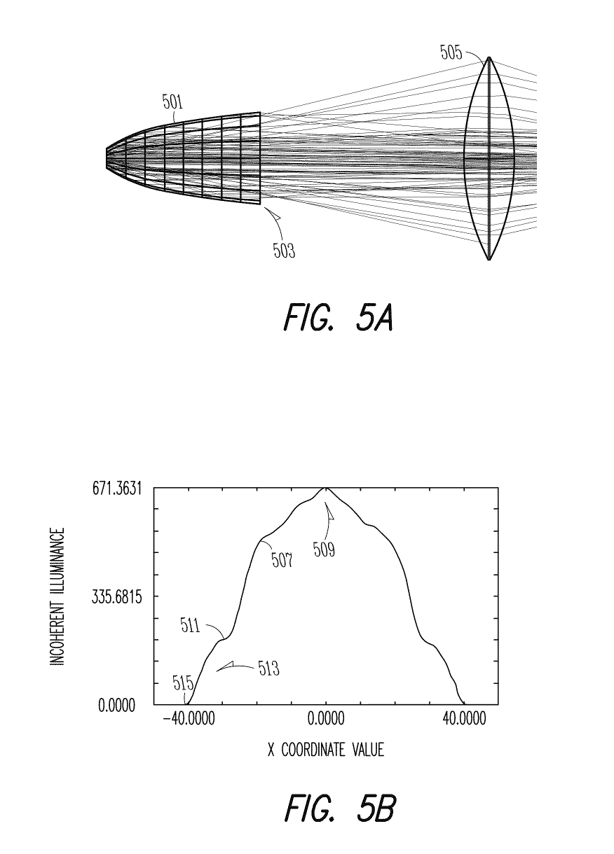

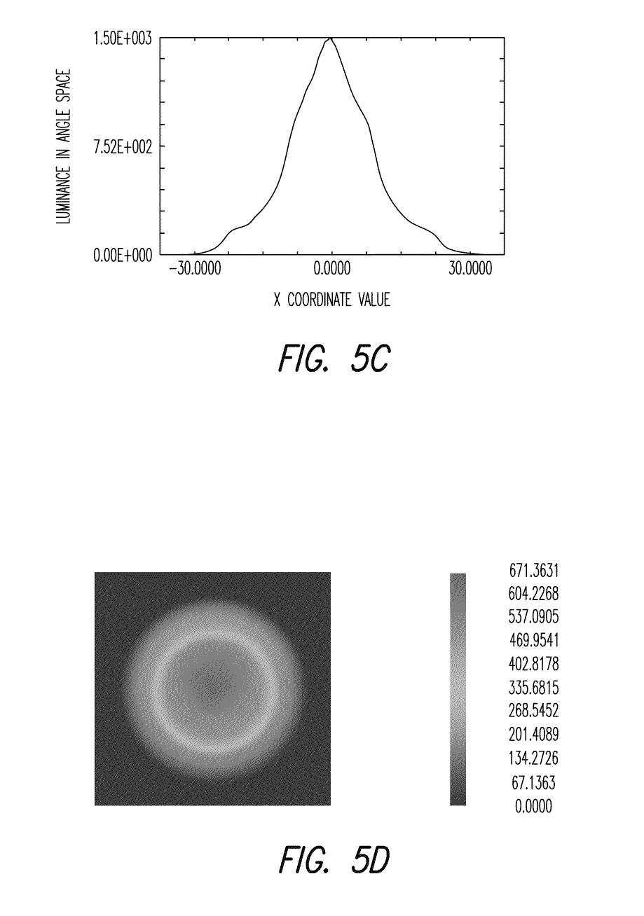

FIG. 5A shows an example embodiment where a non-imaging optic 501 is used to collect light from a directional light source (not shown) and channel it through an aperture 503. The aperture 503 in this example embodiment is the CPC exit face. The exit ray bundle passes through a lens 505 that creates an image of the aperture (also not shown). Characteristics of an example embodiment of the directional light source are described with reference to FIG. 3A, above.

The non-imaging optic 501 is designed to convert the input distribution of the source to the desired output distribution. There can be several requirements for the output distribution depending on application such as brightness uniformity, angular uniformity, color uniformity, beam diameter, and exit angle. The following method may be used in designing the non-imaging optic including characterizing the Etendue of the light source, selecting an exit beam angle for a simple lens design (e.g., at f/2.5), calculating the exit beam area assuming no increase in Etendue, and optimizing the non-imaging optic 501 to deliver a required exit beam. The non-imaging optic design is used for several reasons including a more efficient light collection for a given exit aperture Etendue, a more compact optic compared to a parabolic or elliptical solution, and a partial homogenization of spatial color non-uniformity in the source.

The design may start with a generic non-imaging optic and then the optic is customized for a particular application or applications. Where the source has high uniformity and is almost Lambertian, a compound parabolic collector (CPC) can be chosen as a good starting point for the design. The CPC may be truncated at either or both ends to optimize for size and efficiency. Where overfill of the lens is a design challenge (as is often the case for low beam angle systems), a Compound Elliptical

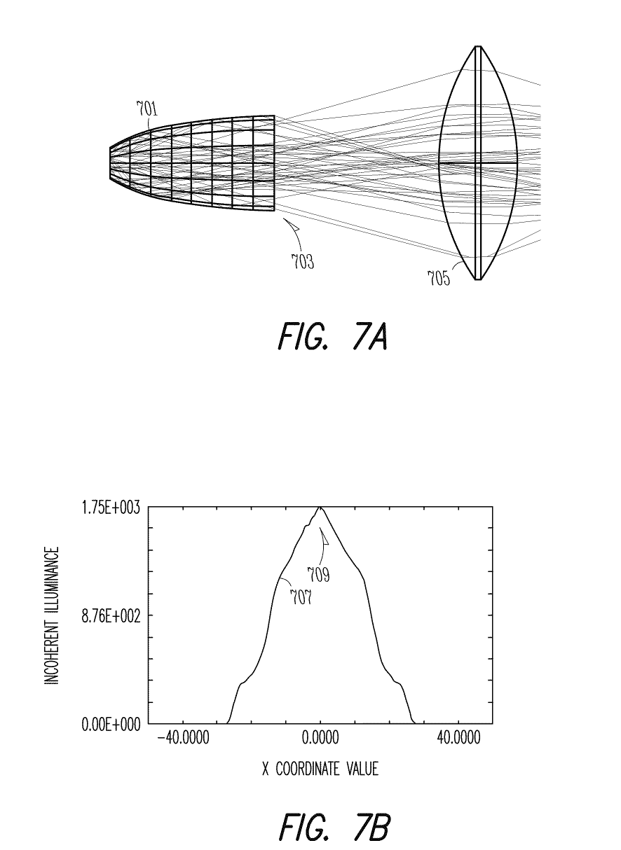

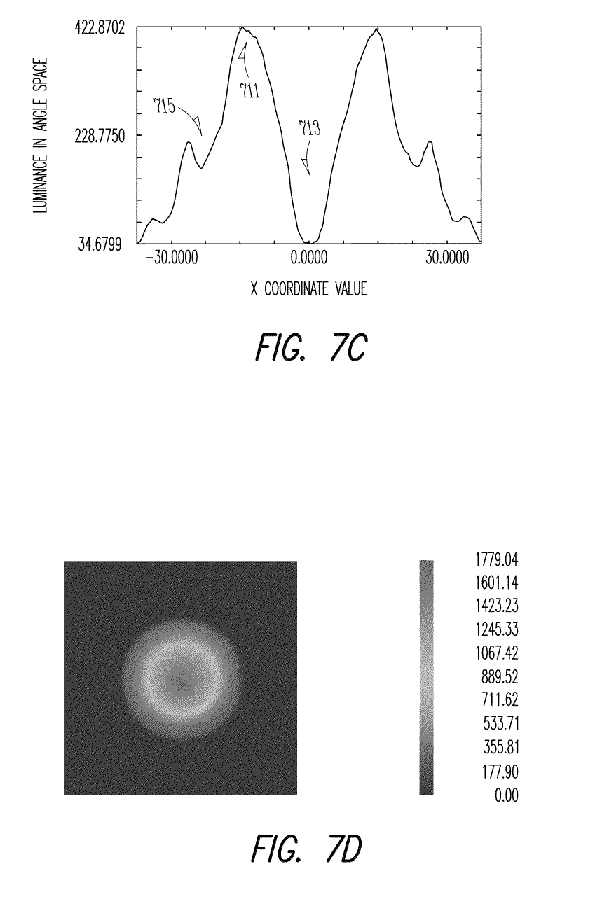

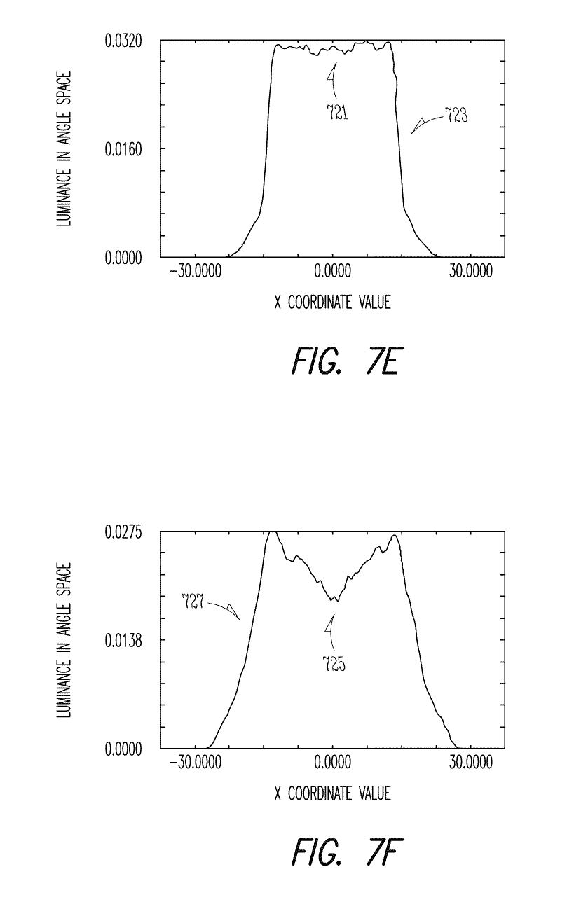

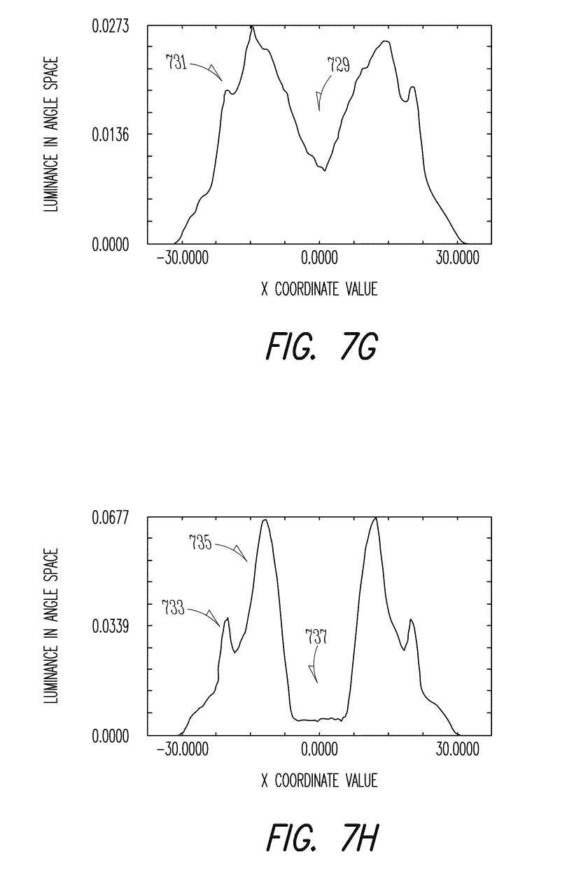

Collector (CEC) may be chosen as a good starting point for the design. In this example embodiment, the light source is placed at the entry face of the CEC. The CEC surface is optimized considering the target exit aperture, object distance, and lens diameter. Where a source has significant horizon rays (as is the case for the protruding bulb source modeled in, for example, FIGS. 5A and 7A), a Θi|Θo collector is a good starting point for the design.

FIGS. 5B, 5C, and 5D show the exit beam spatial distribution, angular distribution, and brightness contour respectively. The non-imaging optic parameters for this example design include an input radius of 6.5 mm, and output radius of 33 mm, a length of 100 mm, with a starting design employing a compound parabolic concentrator.

Table 5, below, shows the parameters and performance of the of this example non-imaging optic system compared to a conventional elliptical reflector system in common use. The analysis assumes a surface reflectance of 90% for the non-imaging optic. The comparison was done for a projection system with an image beam angle of 26° and a large CPC having an input radius of 6.5 mm.

TABLE 5
Non-imaging System compared to a Conventional System

| | | Non-Imaging | Conventional |
|---|---|---|---|
| Parameter | | Optic | Spot |
| Source | Source | LIFI-STA-40-02 | Osram 150W |
| | Wall Plug Power | 260 | 176 |
| | Source Watts | 180 | 150 |
| | Source Lumens | 18,000 | 15,500 |
| | CCT | 6,000 | 3,200 |
| | CRI | 95 | 90 |
| Collection | Aperture Diameter | 66 | 75 |
| | Exit Beam Angle | f2.5 | f1.3 |
| | Source-Aperture Distance | 100 | 175 |
| | Collection Efficiency | 86% | 63% |
| | Brightness Uniformity | 1.8 | 2.5 |
| Lens | Object Distance | 146 | 250 |
| | Imaging Lens Diameter | 130 | 220 |
| | Transmission Efficiency | 90% | 95% |
| System | System Output | 14009.76 | 9277 |
| | System Length | 246 | 395 |
| | System Diameter | 130 | 120 |
| | System Efficiency (%) | 78% | 60% |
| | System Efficiency (LPW) | 54 | 53 |

It can be seen that the directional source and non-imaging optic offer similar system efficacy (53-54 LPW) in a much smaller form factor (246 mm length versus a 395 mm length) than conventional systems. In addition, the directional source and non-imaging optics offer higher system optical efficiency than conventional optics (78% versus 60%). As more efficacious directional sources are employed, the optical efficiency advantage translates into a system efficacy advantage.

With reference again to FIG. 5A, it can be seen that non-imaging optic 501 is compact and that, on this example embodiment, it is abutted to the directional source. This allows the opportunity for different non-imaging optics (NIOs) to be swapped in and out of the illumination system. This can be done manually or by presenting a selection of NIOs in a carousel and rotating an appropriate NIO into place when needed. The carousel of NIOs may be used to provide a range of aperture styles, sizes, or f-numbers. This technique can be used to change the beam angle of the system as an alternative to swapping out the imaging lens.

With reference to FIG. 5B, it can be seen that the system has a pair of shoulders 507 that define the central bright region. There is a central hot spot 509 that is about 20% brighter than the pair of shoulders 507. This level of the central hot spot 509 is generally acceptable. Towards the outside of the central hot spot 509 there is a second pair of shoulders 511 after which the brightness experiences a gradual roll-off 513 to an edge of the beam 515. In some applications, an abrupt roll-off is preferred creating a sharp bright edge to the central spot. This can be accomplished by trimming the beam.

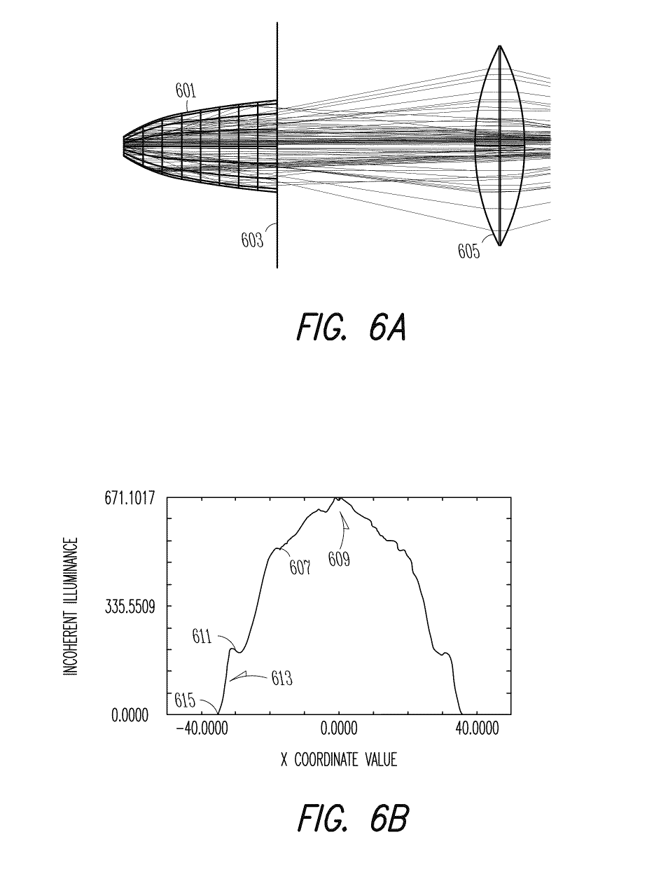

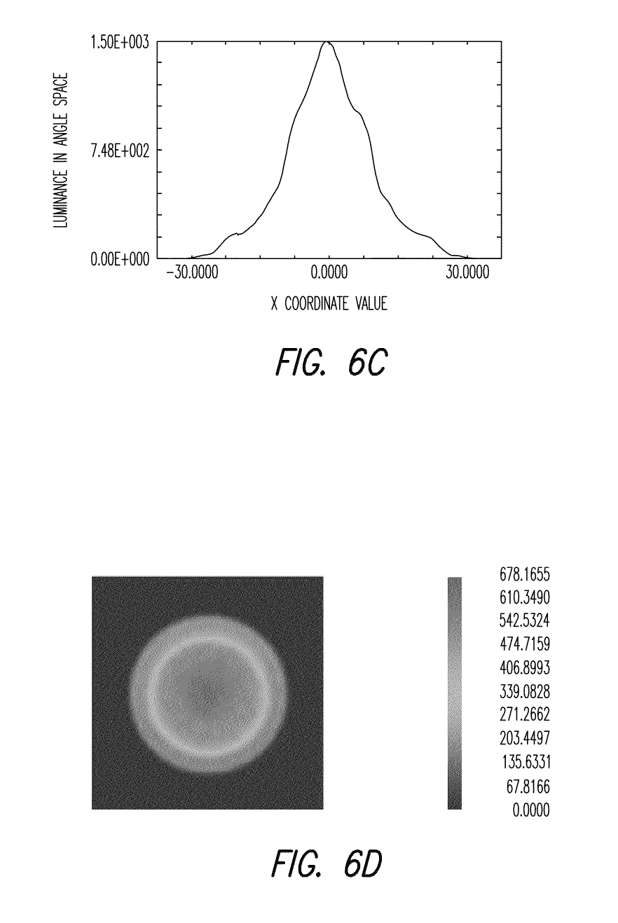

FIG. 6A shows a related example embodiment where a reflective aperture 603 is placed at the exit face of a non-imaging optic 601. The effect of the reflective aperture 603 is to trim the exit beam radius from its original 33 mm down to 28 mm. All other aspects of the system, such as a lens element 605, are left the same. Trimming can be done with a fixed aperture or an iris. FIGS. 6B, 6C, and 6D show the exit beam characteristics of the system. FIG. 6B is shown as having a central hot spot 609, a pair of shoulders 607 defining the central region, and a second pair of shoulders 611 after which the brightness experiences a roll-off 613. Comparing the roll-off 613 in FIG. 6B to the gradual roll-off 513 in FIG. 5B, it can be seen that adding the reflective aperture 603 has created a steeper slope to the roll-off 613 and a sharper edge 615. Table 6, below, compares the performance of the apertured system (using a large CPC having an input radius of 6.5 mm) to the basic NIO system. The aperture improves uniformity at the cost of throughput efficiency.

TABLE 6
Exit Beam Aperture Trimmed compared to full Exit Beam

| | | Trimmed Exit | Conventional |
|---|---|---|---|
| Parameter | | Beam | Spot |
| Source | Source | LIFI-STA-40-02 | Osram 150W |
| | Wall Plug Power | 260 | 176 |
| | Source Watts | 180 | 150 |
| | Source Lumens | 18,000 | 15,500 |
| | CCT | 6,000 | 3,200 |
| | CRI | 95 | 90 |
| Collection | Aperture Diameter | 66 | 75 |
| | Exit Beam Angle | f2.5 | f1.3 |
| | Source-Aperture Distance | 100 | 175 |
| | Collection Efficiency | 86% | 63% |
| | Brightness Uniformity | 1.8 | 2.5 |
| Lens | Object Distance | 146 | 250 |
| | Imaging Lens Diameter | 130 | 220 |
| | Transmission Efficiency | 90% | 95% |
| System | System Output | 14009.76 | 9277 |
| | System Length | 246 | 395 |
| | System Diameter | 130 | 120 |
| | System Efficiency (%) | 78% | 60% |
| | System Efficiency (LPW) | 54 | 53 |

The example embodiments outlined in FIGS. 5A-5D and FIGS. 6A-6D simplifies the lens design (f/2.5 lens versus an f/1.3 lens) and shortens the optical system (246 mm versus 395 mm). In some applications, it may be desirable to shrink further the system at the expense of a slightly more complicated lens design.

FIG. 7A shows a related example embodiment where the exit beam f-number of a non-imaging optic 701 is relaxed from f/2.5 to f/1.5. The embodiment of FIG. 7A is shown to include the non-imaging optic 701 collecting light from a directional light source (not shown) and channeling the light through an aperture 703. The aperture 703 in this example embodiment is the exit face of the non-imaging optic 701. Due to conservation of Etendue, relaxing the exit beam angle enables a smaller optic, which in turn enables a smaller optical system. FIGS. 7B, 7C, and 7D show the exit beam characteristics of this system while Table 7, below, compares the performance of this system to the basic NIO system from FIG. 4.

TABLE 7
Non-Imaging System (f/1.5) compared
to Non-Imaging System (f/2.5)

| Parameter | | NIO f/1.5 | NIO f/2.5 |
|---|---|---|---|
| Source | Source | LIFI-STA- | LIFI-STA- |
| | | 40-02 | 40-02 |
| | Wall Plug Power | 260 | 260 |
| | Source Watts | 180 | 180 |
| | Source Lumens | 18,000 | 18,000 |
| | CCT | 6,000 | 6,000 |
| | CRI | 95 | 95 |
| Collection | Aperture Diameter | 40.5 | 66 |
| | Exit Beam Angle | f/1.5 | f/2.5 |
| | Source-Aperture Distance | 70 | 100 |
| | Collection Efficiency | 86% | 86% |
| | Brightness Uniformity | 1.8 | 1.8 |
| Lens | Object Distance | 87 | 146 |
| | Imaging Lens Diameter | 100 | 130 |
| | Transmission Efficiency | 90% | 90% |
| System | System Output | 13857.48 | 14009.76 |
| | System Length | 157 | 246 |
| | System Diameter | 100 | 130 |
| | System Efficiency (%) | 77% | 78% |
| | System Efficiency (LPW) | 53 | 54 |

Referring to Table 7, above, it is clear that the approach used in the embodiment of FIG. 7A further shrinks the system (from 246 mm L×130 mm D to 157 mm L×100 mm D). However there are tradeoffs in both lens design and distribution at the CPC exit face.

With reference again to the embodiment of FIG. 7A, a lens 705 is made from a glass with a refractive index of 1.5, an outer diameter of 100 mm, and a central thickness of 34 mm. Although the lens 705 can be designed and fabricated with standard techniques, the lens thickness increases weight and cost.

Referring now to FIG. 7B, a pair of shoulders 707 of the central beam is less pronounced than in previous graphs and a hot spot 709 of the beam is about 30% brighter than the pair of shoulders 707. In many applications this level of the hot spot 709 would be unacceptable.

Referring to FIG. 7C, it can be seen that the angular distribution has a pronounced peak 711 and that there is a shortage of on-axis rays 713. This is unfortunate as on-axis rays typically have highest transmission through the system and best performance in dichroic filters and other devices used in conjunction with the system.

The appearance of a hole in the angular distribution (i.e., the shortage of the on-axis rays 713) indicates that the non-imaging optic is not optimally matched to the source. To understand the situation, modeling a Lambertian emitter (using an 8 mm disk) coupled to a Compound Parabolic Concentrator (CPC with an 8 mm entrance face), a particular form of non-imaging optic (see FIG. 7E) is produced. The CPC is designed with an acceptance angle of f/2.5)(12°. Referring to FIG. 6E, the emitter fills out the entire acceptance angle of the CPC.

However, the directional light source embodiment used in FIGS. 5A, 6A, and 7A is not a perfect Lambertian emitter. With reference again to FIG. 3D, the spatial distribution of this embodiment is clearly non-uniform. The source has the central hot spot 351 followed by a lower brightness annulus 353 and the brighter outside ring 355. The central hot spot 351 is created by the high temperature plasma discharge, while the lower brightness annulus 353 represents a cooler area closer to the bulb walls. The brighter outside ring 355 is caused by light traveling along the bulb due to total internal reflection (TIR). FIG. 3E compares the angular distribution of a source 357 to a Lambertian distribution 359. The two distributions are scaled to match at a peak 361. Studying the angular distribution of FIG. 3E, it can be seen that the directional source has a broader distribution both as you move away from normal 363 and at extreme horizon rays 365. This is because this particular embodiment is an extended source housed in a bulb that protrudes above the surface of the puck. As you move off normal, you see fewer rays from the end of the arc but more rays from the wall of the arc. Furthermore, for reasons of thermal management and assembly, the embodiments described with reference to FIGS. 5A to 7A allowed a clearance ring between the bulb outer diameter (d=8 mm) and the non-imaging optic inner face (d=13 mm).

Referring again to FIG. 7E, the angular distribution at the CPC exit face for a system where a Lambertian emitter is connected to an ideal CPC is shown. The Lambertian emitter is a disk having a radius of 4 mm and the CPC is designed to provide an f/1.5 exit beam. It can be seen from FIG. 7E that the angular distribution at the output has a uniform central section 721 and a sharp drop-off at the acceptance angle 723. In FIGS. 7F and 7G, the Lambertian source has been pushed inside the CPC entry face by amounts of 2 mm and 4 mm respectively. In FIG. 7H, the Lambertian source sits inside the entry face by an amount of 4 mm and the diameter of the Lambertian disk has been reduced from 4 mm to 2 mm. The diameter of the CPC entry face has been left unchanged at 4 mm. Referring concurrently to FIGS. 7F through 7H, the emergence of the hole 725, 729, 737 in the angular distribution that was observed for the non-Lambertian embodiment of FIG. 7A is observed. Furthermore, drop-off angles 727, 731, 735 remain relatively unchanged. Additionally, there is the appearance of a secondary peak 733 similar to that seen for the non-Lambertian source 715 (see FIG. 7C). Given these observations, a correction for the angular distribution for this embodiment of source is discerned.

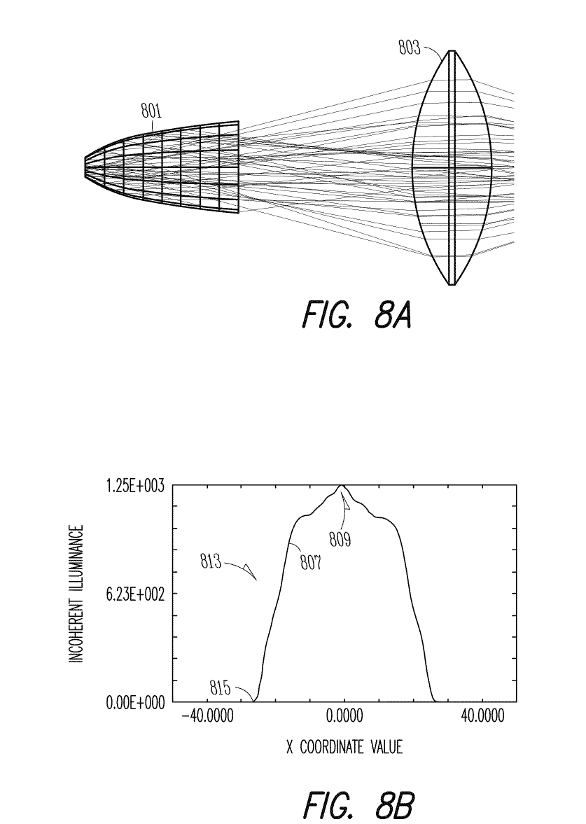

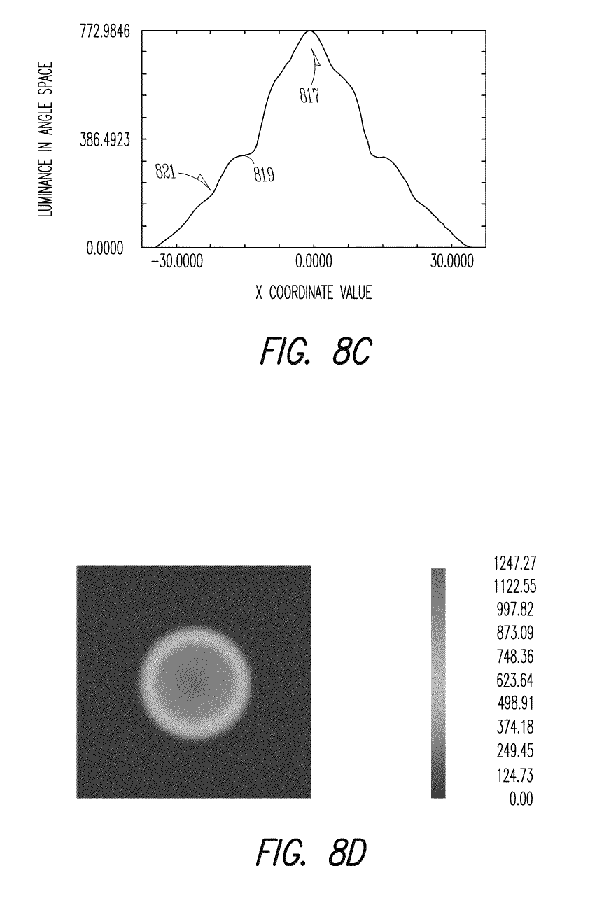

FIG. 8A shows an example embodiment related to FIG. 7A except that the input radius of the non-imaging optic 801 is now reduced to match the outer radius of the bulb (r=4 mm, the bulb is not shown). The exit ray bundle passes through a lens 803. The input beam Etendue of the non-imaging optic 801 is TA or 157 mm²-sr. According to the Lumens-Etendue characterization of the source (see FIG. 3I), this embodiment may result in low collection efficiency with a maximum collection efficiency of about 71%. FIGS. 8B, 8C, and 8D show the exit beam characteristics of the example embodiment of FIG. 8A while Table 8, below, compares this system to the similar system with a larger input radius (described with reference to FIG. 7A, above).

Referring now to FIG. 8B, shoulders 807 are seen with a hot spot 809 that is only 10% brighter than the shoulders 807. Furthermore, there is a steep drop-off 813 in brightness to an edge 815 with no secondary shoulder. This is a highly desirable spatial distribution with good uniformity, minimal hotspot and a sharp fall-off in brightness to the edge 815. Spatial irregularities in the source (see FIG. 3D) have been homogenized.

In contrast, referring to FIG. 8C, the acceptance angle of the optic is not uniformly filled. A peak 817 is for on-axis rays where the intensity is almost twice as high as for the shoulders 819. Furthermore, there is a gradual drop-off 821 in angular intensity beyond the shoulders 819. Each phenomenon just described can be understood by relating back to the characteristics of the directional source and the non-imaging optic. The strong content of on axis rays is because the hot spot of the source is now centered in a matched NIO. In this well matched situation, rays that are spatially central at the input face are transformed into rays that are angularly central at the exit face leading to the strong on axis content, at the peak 817. Furthermore, rays originating from the extended source above the input face of the NIO result in rays that can be outside the acceptance angle of the NIO leading to the high presence of rays beyond the acceptance angle.

TABLE 8
Non-imaging Optics Comparison (r = 6.5 mm versus r = 4 mm)

| | | Radius | Radius |
|---|---|---|---|
| Parameter | | 6.5 mm | 4 mm |
| Source | Source | LIFI-STA- | LIFI-STA- |
| | | 40-02 | 40-02 |
| | Wall Plug Power | 260 | 260 |
| | Source Watts | 180 | 180 |
| | Source Lumens | 18,000 | 18,000 |
| | CCT | 6,000 | 6,000 |
| | CRI | 95 | 95 |
| Collection | Aperture Diameter | 40.5 | 40.5 |
| | Exit Beam Angle | f1.5 | f 1.5 |
| | Source-Aperture Distance | 70 | 70 |
| | Collection Efficiency | 86% | 86% |
| | Brightness Uniformity | 1.8 | |
| Lens | Object Distance | 87 | 87 |
| | Imaging Lens Diameter | 100 | 80 |
| | Transmission Efficiency | 90% | 90% |
| System | System Output | 14009.76 | 14009.76 |
| | System Length | 157 | 157 |
| | System Diameter | 100 | 80 |
| | System Efficiency (%) | 78% | 78% |
| | System Efficiency (LPW) | 54 | 54 |

It can be seen from Table 8, above, that this embodiment has similar performance in terms of size and efficiency. However, comparing FIG. 8B with FIG. 7B it can be seen that the smaller radius system delivers better exit beam spatial uniformity. In this application, spatial uniformity is most important as the exit face is reimaged with a lens. Angular uniformity is only important to the extent that it affects the lens collection efficiency and the filter color performance.

Referring to the imaging lens employed in FIG. 7A, this lens had a diameter of 100 mm and a central thickness of 34 mm. As explained above, this lens was developed for a system with a 26° beam angle. Low beam angle applications (e.g., a beam angle less than 10°), commonly require long focal length lenses and result in lens designs where the lens diameter is a fraction of the focal length. In these cases, example embodiments employing non-imaging optics can be especially advantageous.

FIG. 9A shows a related example embodiment where an imaging lens 905 is designed with a beam angle of 6° (as compared to the previous designs where the imaging beam angle was 26°). The embodiment of FIG. 9A is shown to include the non-imaging optic 901 collecting light from a directional light source (not shown) and channeling the light through an aperture 903. The aperture 903 in this example embodiment is the exit face of the non-imaging optic 901. As the imaging beam angle is reduced, the object distance increases for a given object size. At the same time, the focal length of the lens increases. FIGS. 9B, 9C, and 9D show exit beam characteristics of this system while Table 9A, below, compares system parameters assuming three different the imaging lens sizes of 300 mm, 260 mm, and 220 mm.

TABLE 9A
A comparison of several f 2.5 truncated non-imaging optics designs
for an image projection system with an image beam angle of 6°

| Parameter | | truncated @ f/2.5 | | |
|---|---|---|---|---|
| Source | Source | LIFI-STA-40-01 | | |
| | Wall Plug Power | 260 | 260 | 260 |
| | Source Watts | 180 | 180 | 180 |
| | Source Lumens | 18,000 | 18,000 | 18,000 |
| | CCT | 6,000 | 6,000 | 6,000 |
| | CRI | 95 | 95 | 95 |
| Collection | Aperture Diameter | 20.2 | 20.2 | 20.2 |
| | Exit Beam Angle | f2.5 | f2.5 | f2.5 |
| | Source-Aperture Distance | 70 | 70 | 70 |
| | Collection Efficiency | 86% | 86% | 86% |
| | Brightness Uniformity | 1 | 1 | 1 |
| Lens | Object Distance | 385 | 385 | 385 |
| | Imaging Lens Diameter | 300 | 260 | 220 |
| | Imaging Lens Thickness | 70 | 50 | 38 |
| | Transmission Efficiency | 88% | 78% | 66% |
| System | System Output | 13549.536 | 12009.82 | 10162.15 |
| | System Length | 455 | 455 | 455 |
| | System Diameter | 300 | 260 | 220 |
| | System Efficiency (%) | 75% | 67% | 56% |
| | System Efficiency (LPW) | 52 | 46 | 39 |

Referring to Table 9A, above, it can be seen that the long object distance combined with the truncated non-imaging optic causes either low system efficiency (due to overfill of the lens) or an unmanageably large and thick lens.

FIG. 9E shows a related example embodiment again for a system where the imaging beam angle is 6°. In this example embodiment, an exit beam angle of a non-imaging optic 921 has been relaxed to f/1.5 and care has been taken to avoid truncating the non-imaging optic 921. An aperture 923 in this example embodiment is the exit face of the non-imaging optic 921. FIGS. 9F, 9G, and 9H show the exit beam characteristics of this system while Table 9B, below, compares system parameters assuming three different the imaging lens sizes of 300 mm, 260 mm, and 220 mm.

FIG. 9F shows central beam shoulders 925 and a beam hot spot 927. The beam hot spot 927 is about 20% brighter than the central beam shoulders 925. Beyond the shoulders the beam falls off sharply 929 to a beam edge 931. FIG. 9G shows the angular distribution of the beam, with a dip 933 at the normal as described above with reference to other embodiments.

TABLE 9B
A comparison of several f/1.5 full length non-imaging optics designs
for an image projection system with an image beam angle of 6°

| Parameter | | full length @ f/1.5 | | |
|---|---|---|---|---|
| Source | Source | LIFI-STA-40-01 | | |
| | Wall Plug Power | 260 | 260 | 260 |
| | Source Watts | 180 | 180 | 180 |
| | Source Lumens | 18,000 | 18,000 | 18,000 |
| | CCT | 6,000 | 6,000 | 6,000 |
| | CRI | 95 | 95 | 95 |
| Collection | Aperture Diameter | 12.4 | 12.4 | 12.4 |
| | Exit Beam Angle | f1.5 | f1.5 | f1.5 |
| | Source-Aperture Distance | 50 | 50 | 50 |
| | Collection Efficiency | 86% | 86% | 86% |
| | Brightness Uniformity | 1 | 1 | 1 |
| Lens | Object Distance | 236 | 236 | 236 |
| | Imaging Lens Diameter | 300 | 260 | 220 |
| | Imaging Lens Thickness | 115 | 85 | 60 |
| | Transmission Efficiency | 93% | 87% | 78% |
| System | System Output | 14396.4 | 13467.6 | 12074.4 |
| | System Length | 286 | 286 | 286 |
| | System Diameter | 300 | 260 | 220 |
| | System Efficiency (%) | 80% | 75% | 67% |
| | System Efficiency (LPW) | 55 | 52 | 46 |

Referring to Table 9B, above, it can be seen that adopting a full-length design has improved efficiency by about 5% to 10%. However, the lower f-number has reduced the object size, which reduces object distance and focal length. This leads to a short, stout lens (f≈236 mm, D=220 mm, t=60). The weight and expense of this lens can be reduced by adopting a Fresnel type design. The tradeoff in adopting a Fresnel design is that a diffusing technique is used to smooth out the ring pattern Fresnel design. This diffusion technique can reduce the edge beam quality. In cases where a Fresnel design cannot be used, it may be desirable to enable a thinner lens.

FIG. 91 shows a related example embodiment for a system where the imaging beam angle is 6°. The embodiment of FIG. 9A is shown to include a non-imaging optic 941 collecting light from a directional light source (not shown) and channeling the light through an aperture 943. The aperture 943 in this example embodiment is the exit face of the non-imaging optic 941. In this example embodiment, an exit beam angle of the non-imaging optic 941 has been kept at f/2.5 and care has been taken to avoid truncating the optic. FIGS. 9J, 9K, and 9L show the exit beam characteristics of this system while Table 9C, below, compares system parameters assuming three different the imaging lens sizes of 300 mm, 260 mm, and 220 mm.

FIG. 9J shows central beam shoulders 947 and a beam hot spot 949. The beam hot spot 949 is only 10% brighter than the central beam shoulders 947. Beyond the central beam shoulders 947, the beam falls off sharply 951 to a beam edge 953. FIG. 9K shows the angular distribution of the beam, with shoulders 955 at the acceptance angle and a maximum along the optical axis 957. This differs from the angular distribution in FIG. 9G.

The non-Lambertian distribution of the directional source has two competing effects impacting the strength of on-axis rays. The hot spot effect refers to the bright spot in the center (see FIG. 3D, 351) that tends to increase the number of on-axis rays. The extended source effect refers to the rays originating inside the face of the CPC that tends to reduce the number of on-axis rays.

In the short f/1.5 optic, the extended source effect dominates as many of these rays leave the optic with one or even zero wall reflections. In the longer f/2.5 optic, the hot spot effect dominates creating maximum angular strength on axis.

TABLE 9C
A comparison of several f/2.5 full-length non-imaging optic designs
for an image projection system with an image beam angle of 6°

| Parameter | | full length @ f/2.5 | | |
|---|---|---|---|---|
| Source | Source | LIFI-STA-40-01 | | |
| | Wall Plug Power | 260 | 260 | 260 |
| | Source Watts | 180 | 180 | 180 |
| | Source Lumens | 18,000 | 18,000 | 18,000 |
| | CCT | 6,000 | 6,000 | 6,000 |
| | CRI | 95 | 95 | 95 |
| Collection | Aperture Diameter | 20.2 | 20.2 | 20.2 |
| | Exit Beam Angle | f2.5 | f2.5 | f2.5 |
| | Source-Aperture Distance | 124 | 124 | 124 |
| | Collection Efficiency | 86% | 86% | 86% |
| | Brightness Uniformity | 0.7 | 0.7 | 0.7 |
| Lens | Object Distance | 385 | 385 | 385 |
| | Imaging Lens Diameter | 300 | 260 | 220 |
| | Imaging Lens Thickness | 70 | 50 | 38 |
| | Transmission Efficiency | 88% | 82% | 73% |
| System | System Output | 13549.54 | 12625.7 | 11239.96 |
| | System Length | 509 | 509 | 509 |
| | System Diameter | 300 | 260 | 220 |
| | System Efficiency (%) | 75% | 70% | 62% |
| | System Efficiency (LPW) | 52 | 49 | 43 |

Referring to Table 9C, above, it can be seen that adopting a full length design has improved the efficiency by about 5% to 7% and maintained a manageable thin lens design (f≈385 mm, D=220 mm, t=38). This lens can be manufactured without going to a Fresnel structure.

The system of Table 9C compares very favorably in size and efficiency with low beam angle (long throw follow spot) systems in use today. In fact, as the beam angle is reduced, the advantages of using a non-imaging optics approach become more pronounced since lower beam angle systems have a smaller exit beam Etendue for a given imaging lens area. As such, in order to avoid deploying very large lenses, it can be useful to ensure that the illumination system does a good job of preserving Etendue.

Conventional imaging systems address this issue by using very low Etendue sources (e.g., a xenon lamp or short-arc metal halide lamps) and then trimming the beam as needed at the aperture. A xenon lamp has a low Etendue but also low efficacy (40 LPW). As a result many Xenon based imaging systems struggle to achieve a system efficacy above 20 LPW. The short-arc metal halide lamps have higher efficacy (110 LPW) but also higher Etendue. Because of the high Etendue, many imaging based metal halide long throw systems struggle to get a system efficacy of above 20 LPW. In addition, for light outputs of 10,000 Lumens and above, these systems tend to be over 1 meter in length.

In contrast, the directional light source, non-imaging optics system of Table 9C has a system efficacy of 43 LPW and an overall length of 509 mm. Higher wattage directional light sources allow higher lumens to be delivered in similar system sizes.

A related example embodiment for low beam angle systems is to use the directional source, non-imaging optic and a two-lens design (an example embodiment is discussed, below) to create an even more compact package. In this embodiment, the first lens creates a virtual image of the aperture and the second lens forms a beam from the virtual image.

FIG. 9M shows an example embodiment of an optical layout for a two-lens embodiment while FIG. 9N shows a corresponding spatial distribution. Light leaves the directional source (not shown) and travels through a CPC based NIO 961. The NIO 961 has an exit face 963 that forms an aperture. A first lens 965 is positioned such that the aperture lies about halfway between the first lens 965 and its focus. As such, the first lens 965 forms a virtual image 967 of the aperture positioned behind the CPC. The virtual image 967 acts as an object to a second lens 969 that brings it to focus in an end spot (not shown). Several lens design options are available that can lead to a shorter overall system at the expense of adding a second lens.

The example embodiment of the two-lens approach can be used with the NIO to produce systems that are shorter and smaller in diameter. Applying this approach to the system described in Table 9C achieves the following example results.

| | |
|---|---|
| NIO: | f/1.5, D = 24 mm, L = 45 mm |
| Lens 1: | f = 250 mm, D = 70 mm, t = 6 mm @ |
| | 120 mm from exit face |
| Lens 2: | f = 400 mm, D = 80 mm, t = 4 mm @ |
| | 285 mm from exit face |
| System Efficiency: | 77% |
| Overall Dimension (L × D): | 330 mm × 80 mm |

This system compares favorably to any of the single lens systems of Table 9C.

FIG. 10A shows a related example embodiment where a two-stage non-imaging optic 1000. The two-stage non-imaging optic 1000 of FIG. 10A is shown to include a first-stage non-imaging optic 1001 and a second-stage non-imaging optic 1003. In this embodiment, the first-stage non-imaging optic 1001, which may also be referred to as a homogenizer stage, is designed to improve brightness, color, and angular uniformity. The second-stage non-imaging optic 1003 serves to modify the angular distribution to match the acceptance of the projection lens. There are distinct advantages to using this example approach when high uniformity is desired.

FIG. 10B shows the angular distribution at the exit face of the first-stage non-imaging optic 1001 while FIGS. 10C and 10D show the spatial and angular distribution at the exit face of the two-stage non-imaging optic 1000. In this embodiment, the beam brightness, color, and angle are homogenized by redirecting (e.g., bouncing) rays from one part of the beam into another. A level of homogenization increases with the number of bounces. Clearly, homogenizing the beam while the beam width is small and the angular extent is large allows a large number of redirects to occur in a compact optic. The first-stage non-imaging optic 1001 may be implemented in several ways by, for example, by recessing the bulb into the puck (not shown) and using the reflective powder as a scattering light-tube, or placing a small scattering or reflective lightpipe around the bulb.

As a general function of the second-stage non-imaging optic 1003 is to reduce an angular extent while growing the beam width, it is clear that the first-stage non-imaging optic 1001 provides a better exit beam uniformity for a given size constraint. An advantage of adding a homogenization stage depends on a discrepancy between source non-uniformity and a desired spot uniformity.

FIG. 11A shows an example embodiment of the directional light source where an axis of the bulb 1103 lies parallel to a face of a puck 1101. The optical axis is orthogonal to the axis of the bulb 1103 and runs approximately through the center of the bulb 1103. Light is collected from along the length of the bulb 1103. This arrangement has higher non-uniformity with respect to the desired exit beam characteristics for several reasons including, for example, the source cross-section no longer matches the exit beam, the source bright spot is no longer coincident with the exit bright spot, and the brightness variation across the source is higher. Nonetheless, a relatively simple first-stage homogenizing optic may produce a beam of the desired characteristic to feed the second-stage non-imaging optic.

FIG. 11B shows a further example embodiment of the directional light-source where a puck 1151 has been designed to minimize a front-back dimension 1153 in this example embodiment by allowing a left-right dimension 1155 to grow. This example arrangement may advantageously reduce an overall length of the beam projection system. A high frequency solid state modeling program can be been used to minimize the puck height while maintaining efficient and reliable energy coupling to a bulb 1157. Furthermore, external components (e.g., discrete components, RF cable lengths, external strip lines, and other options) can be used in combination with the puck design to minimize the z-dimension.

FIG. 12 shows an alternative example embodiment of a non-imaging optic approach based on elliptical surfaces. Light leaves the directional source (not shown) and enters an input face 1201 of a NIO 1203, which is based on a compound elliptical concentrator. The NIO 1203 is designed to ensure that all light entering the input face 1201 passes through an exit face 1205 and then through a remote aperture 1207. This example embodiment may be advantageous where lens size is an important driver of cost and care is taken to avoid overfilling the lens.

FIG. 13 shows an alternative example embodiment of a non-imaging optic approach where a TIR lens 1303 is used to form a beam that feeds a projection lens (not shown). Light from a directional source 1301 passes into the TIR lens 1303 where the light is shaped by refraction at an input face 1305, reflection at an intermediary face 1307, and refraction at an exit face 1309. In this example embodiment, TIR surfaces of the TIR lens 1303 are arranged to create the desired illumination effect. The TIR lens 1303 can be constructed from, for example, a single molding and use only the TIR effect. Alternatively or in addition, the TIR lens 1303 can be assembled from mirrored segments. Refractive faces of the TIR lens 1303 can be flat, convex, or concave adding another design dimension to create the desired target beam.

FIG. 14 shows another example embodiment where a reflection/refraction approach is used to form a beam that feeds a projection lens. Light travels from a directional source 1401, through a shaping optic 1403 that forms a beam 1405 and channels the beam 1405 through a remote aperture 1407. The shaping optic 1403 is designed with a first refractive input face 1409 and a second refractive input face 1411. The near-axis rays pass through the first refractive input face 1409 and are directed through a first exit face 1413 where the near-axis rays are refracted into a desired beam pattern. Off-axis rays pass through the second refractive input face 1411 and, on first hitting a front TIR surface 1415, are reflected back towards a rear TIR surface 1417, where they are again reflected. This time, the off-axis rays reach the front surfaces, including the first exit face 1413 and a second exit face 1419, at an angle where they break the TIR condition and exit the optic.

In the example embodiments described with reference to FIGS. 13 and 14, the selected optic may be designed to allow an aperture to be placed directly at the exit face or to create a beam that feeds an aperture. In each example embodiment, two advantages include that the beam can be formed in a compact space and the optic can be designed to preserve Etendue between source and target areas.

FIG. 15A shows an optical layout of the prior art for a conventional elliptical moving head profile system. In this layout, it can be seen that an aperture is the last element before a projection lens. The color management, profiling, and dimming effects are placed in the convergent beam between the elliptical reflector and the aperture.

FIG. 15B shows an example embodiment using a directional source and a non-imaging optic. The color management elements are placed in the divergent beam that leaves the non-imaging optic. A lens is used to bring the light back to a second aperture where gobos and an iris are located. The lens may be a conventional lens or a Fresnel lens. An advantage of this example embodiment is that the general layout is similar to that used before, but the beam cross-section can be smaller allowing for smaller color filters and gobo arrays. In these systems, an overall size is often driven by the need to accommodate different color management solutions. As such, the lenses are designed to accommodate the color filters, gobos, and so on rather than simply to minimize size.

FIG. 15C shows another example embodiment using a directional source and a non-imaging optic. In this example embodiment, the iris and gobos are placed directly at the exit face of the non-imaging optic and a lens images these elements to form the beam. In this example embodiment, the beam is divergent through the entire optical train until it reaches the imaging lens. An advantage of this example embodiment is that the collection efficiency through the gobo can be high. A disadvantage is that, in order to accommodate many gobos, it is desirable that the object size be small (e.g., often 25 mm diameter). This means that, for large beam angles, a distance from object to the lens is small. For example, if the exit aperture has a 12 mm radius, and the beam angle is greater than 16°, the distance from the aperture to the lens is less than 100 mm when a single thin lens to be used. This design is compact but restricts the space available for various color management hardware.

A further advantage of the directional light source described in various example embodiments described herein is that directional light source can be dimmed. This effect can be used to advantage in several ways as part of an imaging system.

In one example embodiment, the light source dimming is synchronized to the optical dimming feature of the beam system. The combination provides greater flexibility in dimming as well as energy savings. In another example embodiment, the light source dimming is synchronized to a shutter in the beam system. The combination allows the light source to be dimmed to a low level e.g., less than 30%) when the beam is shuttered off. When the shutter is opened, the source is brought back to full output. This saves energy and extends the life of the source.

In another example embodiment, the light source is dimmed in response to, for example, a digital multiplexing (DMX) strobe command. The deep dimming and rapid response of the light source allows the source itself to create a strobe at any frequency up to about 15 Hz. The dim state of the strobe is approximately 20% while the bright state is 100% output. This strobe has an advantage of being completely silent and involving no wear and tear of a strobe flag or shutter.

Other example embodiments include the use of a solid non-imaging optic and a TIR-based non-imaging optic. The optic itself may be faceted, elongated, or luned. The optic may be followed by a filter or an EMI suppressing mesh. The filter may be a reflective aperture used to pass the high brightness portion of the CPC and recirculate the lower brightness outer annulus of the CPC.

An example goal of the non-imaging optic design approach is to make optimum use of the Lumens-Etendue performance of the source. In several instances, this means that the non-imaging optic be placed in close proximity (e.g., less than 5 mm away) to the light source. Often, the source may be a High Intensity Discharge source with high wall temperatures and high heat flux. The non-imaging optic design can be selected to withstand these conditions.

FIG. 16 shows an example embodiment with a light source 1600 and a non-imaging optic 1650. The light source 1600 is shown to include a bulb 1603 and an energy-coupling device 1601 to couple energy to the bulb 1603. The energy-coupling device 1601 has a front face 1605. The non-imaging optic 1650 is shown to include a non-imaging optic body 1651, a reflective surface 1653, an input aperture 1655, an exit aperture 1657, and a front face 1661. The input aperture 1655 sits in an input face 1659. The front face 1605 of the energy-coupling device 1601 is shown mated to the input face 1659 of the non-imaging optic 1650 such that light from the bulb 1603 is coupled directly into the non-imaging optic 1650.

In one example embodiment, the non-imaging optic body 1651 may be formed from a ceramic material. To create the reflective surface 1653, the ceramic material may be glazed and a dielectric coating applied. To withstand high temperatures generated by the bulb 1603, a high density sputtered coating may be used. The coating properties may be tuned to the thermal and optical requirements of the collection system. The energy-coupling device 1601 may be joined to the non-imaging optic 1650 using a high temperature frit, adhesive, or similar process.

FIG. 17 shows an example embodiment related to the example embodiment of FIG. 16 with a light source 1700 and a non-imaging optic 1750. The light source 1700 is shown to include a bulb 1703 and an energy-coupling device 1701 to couple energy to the bulb 1703. The energy-coupling device 1701 has a front face 1705. The bulb 1703 may be the same or similar to the bulb 1603 of FIG. 16. However, in this example embodiment, the non-imaging optic 1750 may be formed to be similar to a conventional sheet metal collector. The non-imaging optic 1750 is shown to include an outer surface 1751, an inner reflective surface 1753, an input aperture 1755 and an exit aperture 1757. The non-imaging optic 1750 may be formed or machined from turned aluminum or some other reflective material. An enhancing coating may be added to the non-imaging optic 1750 to improve reflectivity of the inner reflective surface 1753.

Material and coating selections can be chosen to account for the thermal environment. A material having a low coefficient of thermal expansion (CTE) (e.g., Invar®, a nickel steel alloy known generically as FeNi₃6) can be used. A high a reflectance improves efficiency. Even when an optical coating is used, a high substrate reflectance may help simplify the coating design.

FIG. 18 shows an example embodiment with a light source 1800 and a non-imaging optic 1850. The light source 1800 is shown to include a bulb 1803 and an energy-coupling device 1801 to couple energy to the bulb 1803. The energy-coupling device 1801 has a front face 1805. The bulb 1803 may be the same or similar to the bulbs described, above. The non-imaging optic 1850 is shown to include an outer surface 1851, an inner reflective surface 1853, an input aperture 1855 and an exit aperture 1857. The non-imaging optic 1850 may be formed or machined from glass. An optical coating may be applied to the inner reflective surface 1853. For example, an enhanced aluminum coating can be used.

FIG. 19 shows an example embodiment with a light source 1900 and a non-imaging optic 1950. The light source 1900 is shown to include a bulb 1903 and an energy-coupling device 1901 to couple energy to the bulb 1903. The energy-coupling device 1901 has a front face 1905. The bulb 1903 may be the same or similar to the bulbs described, above. In this example embodiment, the non-imaging optic 1950 has a solid body 1951 made from glass, quartz, or another optically transparent material. Light leaves the bulb 1903 and enters an input face 1953 of the non-imaging optic 1950. Light passes through the non-imaging optic 1950 and leaves an exit face 1957. Some beams pass directly through the non-imaging optic 1950 while some beam reflect from a reflective surface 1955 and are directed out the exit face 1957. The reflection may be achieved through a TIR condition, or by applying an optical coating to the exterior of the non-imaging optic 1950. The outer surface of the bulb 1903 may be closely coupled to the input face 1953 of the non-imaging optic 1950. In some example embodiments (not shown), the non-imaging optic 1950 may be integral with the bulb 1903. This may be done in a single fabrication process, or by later fusing the elements together.

The descriptions provided herein include illustrative systems, methods, techniques, and instruction sequences that embody at least portions of the inventive subject matter. In the foregoing description, for purposes of explanation, numerous specific details are set forth to provide an understanding of various embodiments of the inventive subject matter. It will be evident, however, to those skilled in the art that embodiments of the inventive subject matter may be practiced without these specific details. Further, well-known instruction instances, materials, coatings, structures, circuits, and techniques have not been shown in detail. Additionally, the above circuits, dimensions, shapes, materials, and operating parameters are examples only and other embodiments may use different circuits, dimensions, shapes, materials, and operating parameters. Moreover, as used herein, the term “or” may be construed in either an inclusive or an exclusive sense. It is therefore understood that each of the above aspects of the example embodiments may be used alone or in combination with other aspects described herein.

What is claimed is:

1. A beam projection system comprising:
a lamp body comprising a dielectric material;
a bulb proximate to the lamp body, the bulb containing a fill that forms a plasma when RF power is coupled to the fill from the lamp body; and
an optical train optically coupled to the bulb, the optical train including:
a non-imaging optical element;
an aperture proximate to the non-imaging optical element; and
at least one imaging lens element.

2. The beam projection system of claim 1 wherein the non-imaging optical element has at least one reflective surface.

3. The beam projection system of claim 1 wherein the non-imaging optical element is a compound parabolic collector.

4. The beam projection system of claim 1 wherein the non-imaging optical element is a truncated portion of a compound parabolic collector.

5. The beam projection system of claim 1 wherein the non-imaging optical element includes a plurality of stages.

6. The beam projection system of claim 5 wherein a first stage of the plurality of stages of the non-imaging optical element is configured to recirculate light formed from the plasma through the bulb.

7. The beam projection system of claim 5 wherein a first stage of the plurality of stages of the non-imaging optical element is a scattering lightpipe configured to homogenize a color spectrum of light generated by the bulb.

8. The beam projection system of claim 1 wherein the non-imaging optical element includes a plurality of facets.

9. The beam projection system of claim 1 wherein the aperture is an annulus at an exit face of the non-imaging optical element.

10. The beam projection system of claim 1 wherein the aperture is a reflective exit face of the non-imaging optical element.

11. A beam projection system comprising:
a directional light source;
a non-imaging optical element optically coupled to receive light emitted from the directional light source;
an aperture proximate to the non-imaging optical element; and
at least one imaging lens element proximate to the aperture.

12. The beam projection system of claim 11 wherein the non-imaging optical element has at least one reflective surface.

13. The beam projection system of claim 11 wherein the non-imaging optical element is a compound parabolic collector.

14. The beam projection system of claim 11 wherein the non-imaging optical element is a truncated portion of a compound parabolic collector.

15. The beam projection system of claim 11 wherein the non-imaging optical element includes a plurality of stages.

16. The beam projection system of claim 15 wherein a first stage of the plurality of stages of the non-imaging optical element is configured to recirculate the emitted light generated by the directional light source.

17. The beam projection system of claim 15 wherein a first stage of the plurality of stages of the non-imaging optical element is a scattering lightpipe configured to homogenize a color spectrum of the emitted light generated by the directional light source.

18. The beam projection system of claim 11 where the non-imaging optical element includes a plurality of facets.

19. A method of producing an image, the method comprising:
producing a beam of light from a directional light source;
directing the beam of light through a non-imaging optical element;
transforming a spatial and angular distribution of the beam of light in the non-imaging optical element; and
forming an output beam from the transformed beam of light.

20. The method of claim 19, further comprising homogenizing a color spectrum of the beam of light generated by the directional light source, the homogenization occurring in the non-imaging optical element.
